(19) United States
(12) Patent Application Publication
(10) Pub. No.: US 2026/0291398 A1
(43) Pub. Date: Sep. 24, 2026

(54) BIDIRECTIONAL DC-DC CONVERTER AND ITS CONTROL METHOD

(71) Applicant: HYUNDAI MOBIS CO., LTD., Seoul (KR)

(72) Inventors: Tae Ho BANG, Yongin-si (KR); Won Gon KIM, Yongin-si (KR); Moon Hwan KEUM, Yongin-si (KR)

(73) Assignee: HYUNDAI MOBIS CO., LTD., Seoul (KR)

(21) Appl. No.: 19/183,303

(22) Filed: Apr. 18, 2025

(30) Foreign Application Priority Data
Jul. 17, 2024 (KR) 10-2024-0094253
Jul. 17, 2024 (KR) 10-2024-0094313

(51) Int. Cl. H02M 3/335

(52) U.S. Cl. CPC H02M 3/33584; H02M 3/33573; H02M 3/33592

(57) ABSTRACT

A bidirectional direct current to direct current (DC-DC) converter, and a control method therefor are provided. The bidirectional DC-DC converter is capable of being operated in a wide input voltage range and simultaneously bucking or boosting a voltage in both directions by suppressing overvoltage occurring in a low-voltage stage.

### CROSS-REFERENCE TO RELATED APPLICATIONS

This application claims priority under 35 U.S.C. § 119 to Korean Patent Application No. 10-2024-0094253 and Korean Patent Application No. 10-2024-0094313, both filed on Jul. 17, 2024 in the Korean Intellectual Property Office, the disclosures of which are incorporated herein by reference in their entirety.

### BACKGROUND

### 1. Field of the Invention

The following disclosure relates to a bidirectional direct current to direct current (DC-DC) converter and its control method, and more particularly, to a bidirectional direct current to direct current (DC-DC) converter capable of preventing charging of a clamp capacitor in a boost mode, and its control method.

In addition, the present disclosure relates to a bidirectional DC-DC converter capable of discharging energy charged in a clamp capacitor before switching from a boost mode to a buck mode, and its control method.

### 2. Description of the Related Art

In recent years, electric vehicles or the like have been equipped with direct current to direct current (DC-DC) converters capable of transmitting power from high-voltage systems such as batteries to low-voltage systems such as vehicle loads. Among these converters, a low voltage DC-DC Converter (LDC) is a power supply device that supplies power to the vehicle load. In general, the LDC may be operated in the buck mode, which reduces a voltage of the high-voltage system to a voltage required by the low-voltage system. However, recently, in order to shorten a charging time of the vehicle, an external charging system may output a voltage of 400 V to 800 V, and accordingly, the LDC installed in a vehicle may also be required to be operated in a wide input voltage range of 200 V to 900 V.

FIG. 1 shows a conventional unidirectional converter, and FIG. 2 shows a conventional bidirectional converter.

Therefore, the unidirectional converter as shown in FIG. 1 may be used as the LDC capable of being operated in the wide input voltage range. However, the converter has recently been required not only to have the wide input voltage range but also to be operated in a boost mode of boosting the voltage of the low-voltage system to that of the high-voltage system. However, it is impossible for the conventional unidirectional converter to be operated in this way. Therefore, the bidirectional converter as shown in FIG. 2 has been used in order to implement the boost mode. However, the bidirectional converter as shown in FIG. 2 has a narrow input voltage range compared to that of the unidirectional converter as shown in FIG. 1.

That is, it is impossible for the unidirectional converter in FIG. 1 to be operated in the boost mode, and the bidirectional converter in FIG. 2 has the narrow input voltage range compared to that of the unidirectional converter in FIG. 1.

### RELATED ART DOCUMENT

### Patent Document

Korean Patent Laid-Open Publication No. 10-2016-0135958 (Nov. 29, 2016)

### SUMMARY

An embodiment of the present disclosure is directed to providing a bidirectional direct current to direct current (DC-DC) converter capable of being operated over a wide input voltage range and simultaneously bucking or boosting a voltage in both directions by preventing a clamp capacitor from being charged during a boost mode operation to thus suppress overvoltage occurring in a low-voltage stage, and its control method.

An embodiment of the present disclosure is directed to providing a bidirectional DC-DC converter capable of being operated over a wide input voltage range and simultaneously bucking or boosting a voltage in both directions by discharging a clamp capacitor when switching from a boost mode to a buck mode to thus suppress overvoltage occurring in a low-voltage stage, and its control method.

In a general aspect of the disclosure, a bidirectional direct current to direct current (DC-DC) converter, includes: a first terminal and a second terminal, each connected to a first power and a second power having a lower potential than the first power; a transformer installed between the first terminal and the second terminal; a high-voltage side totem-pole circuit including first and second switches, and installed between the first terminal and a primary side of the transformer; a cascode circuit including third, fourth, and fifth switches connected in series with one another, and installed between the high-voltage side totem-pole circuit and the primary side of the transformer; a clamp capacitor connected in parallel with the cascode circuit; a secondary-side circuit including sixth and seventh switches and an inductor, and installed between the second terminal and a secondary side of the transformer; an operation mode switching circuit including an eighth switch and a first diode connected in series with each other, and installed between the high-voltage side totem-pole circuit and the cascode circuit; and a controller configured to control at least one of the first to eighth switches, and control the operation mode switching circuit based on a power flow direction between the first and second terminals.

The controller may be further configured to control the eighth switch to be turned off.

In a boost mode, the controller may be further configured to control the fifth switch to be turned off.

In a buck mode, the controller may be further configured to control the first and fourth switches and the second, third, and fifth switches to be complementarily turned on.

In a boost mode, the controller may be further configured to control the first and fourth switches and the second and eighth switches to be complementarily turned on.

The first switch may have one end connected to a positive pole of the first terminal and the other end connected to one terminal on the primary side of the transformer, wherein the second switch may have one end connected to the one terminal on the primary side of the transformer and the other end connected to a negative pole of the first terminal.

The third switch may have one end connected to one end of the clamp capacitor and the other end connected to the other end of the fifth switch, wherein the fourth switch may have one end connected to the other terminal on the primary side of the transformer and the other end connected to the negative pole of the first terminal, wherein the fifth switch may have one end connected to the other terminal on the primary side of the transformer, and wherein the clamp capacitor may have the other end connected to the other end of the fourth switch.

The eighth switch may have one end connected to an anode of the first diode and the other end connected to the positive pole of the first terminal, wherein a cathode of the first diode may be connected to the other terminal on the primary side of the transformer.

A tap may be installed on the secondary side of the transformer, wherein the sixth switch may have one end connected to the other terminal on the secondary side of the transformer and the other end connected to a negative pole of the second terminal, wherein the seventh switch may have one end connected to one terminal on the secondary side of the transformer and the other end connected to the negative pole of the second terminal, and wherein the inductor may have one end connected to the tap of the transformer and the other end connected to a positive pole of the second terminal.

In another general aspect of the disclosure, a control method for the bidirectional direct current to direct current (DC-DC) converter, includes: a mode switching determination step of determining, by a controller, whether a voltage of a first terminal is greater than or equal to a predetermined mode switching reference voltage; and an operation mode switching step of controlling, by the controller, at least one switch among first to eighth switches in a buck mode in response to the voltage of the first terminal being greater than or equal to the mode switch reference voltage.

In yet another general aspect of the disclosure, a bidirectional direct current to direct current (DC-DC) converter, includes: a first terminal and a second terminal, each connected to a first power and a second power having a lower potential than the first power; a transformer installed between the first terminal and the second terminal; a high-voltage side totem-pole circuit including first and second switches, and installed between the first terminal and a primary side of the transformer; a transformer-side totem-pole circuit including third and fourth switches, and installed between the high-voltage side totem-pole circuit and the primary side of the transformer; a clamp capacitor connected in parallel with the transformer-side totem-pole circuit; a secondary-side circuit including fifth and sixth switches and an inductor, and installed between the second terminal and a secondary side of the transformer; an operation mode switching circuit including seventh and eighth switches connected in series with each other, and installed between the high-voltage side totem-pole circuit and the transformer-side totem-pole circuit; and a controller configured to control at least one of the first to eighth switches, and control the operation mode switching circuit based on a power flow direction between the first and second terminals.

In a buck mode, the controller may be further configured to control both the seventh and eighth switches to be turned off.

In a boost mode, the controller may be further configured to control both the seventh and eighth switches to be turned on.

The controller may be further configured to control the first and fourth switches and the second and third switches to be complementarily turned on.

The converter may further include a discharge circuit installed between a common node of the seventh and eighth switches and a primary-side ground, wherein the controller may be further configured to control the seventh switch to be turned off and the eighth switch to be turned on in response to a voltage across the clamp capacitor being greater than a predetermined discharge reference voltage.

The controller may be further configured to control the seventh and eighth switches to be turned off and the third and fourth switches to be turned on in response to a voltage across the clamp capacitor being greater than a predetermined discharge reference voltage.

The first switch may have one end connected to a positive pole of the first terminal and the other end connected to one terminal on the primary side of the transformer, wherein the second switch may have one end connected to the one terminal on the primary side of the transformer and the other end connected to a negative pole of the first terminal.

The third switch may have one end connected to one end of the clamp capacitor and the other end connected to the other terminal on the primary side of the transformer, wherein the fourth switch may have one end connected to the other terminal on the primary side of the transformer and the other end connected to a negative pole of the first terminal, and wherein the clamp capacitor may have the other end connected to the negative pole of the first terminal.

The seventh switch may have one end connected to a positive pole of the first terminal and the other end connected to the other end of the eighth switch, wherein the eighth switch may have one end connected to one end of the clamp capacitor.

A tap may be installed on the secondary side of the transformer, wherein the fifth switch has one end connected to the other terminal on the secondary side of the transformer and the other end connected to a negative pole of the second terminal, wherein the sixth switch may have one end connected to one terminal on the secondary side of the transformer and the other end connected to the negative pole of the second terminal, and wherein the inductor may have one end connected to the tap of the transformer and the other end connected to a positive pole of the second terminal.

Other features and aspects will be apparent from the following detailed description, the drawings, and the claims.

### BRIEF DESCRIPTION OF THE DRAWINGS

FIG. 1 shows a conventional unidirectional converter.

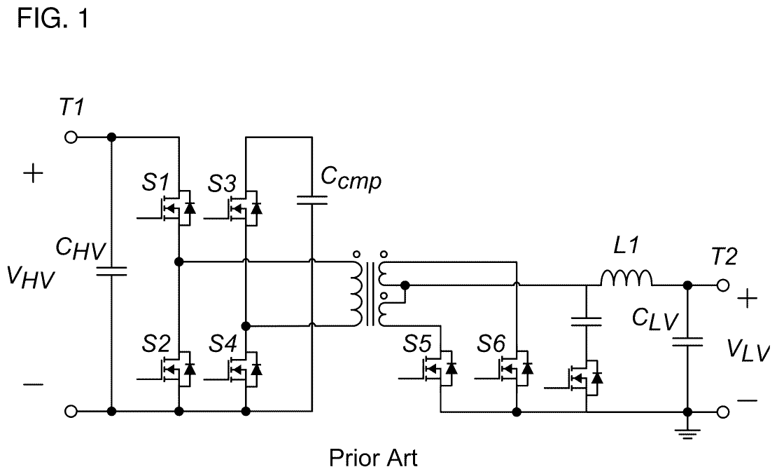

FIG. 2 shows a conventional bidirectional converter.

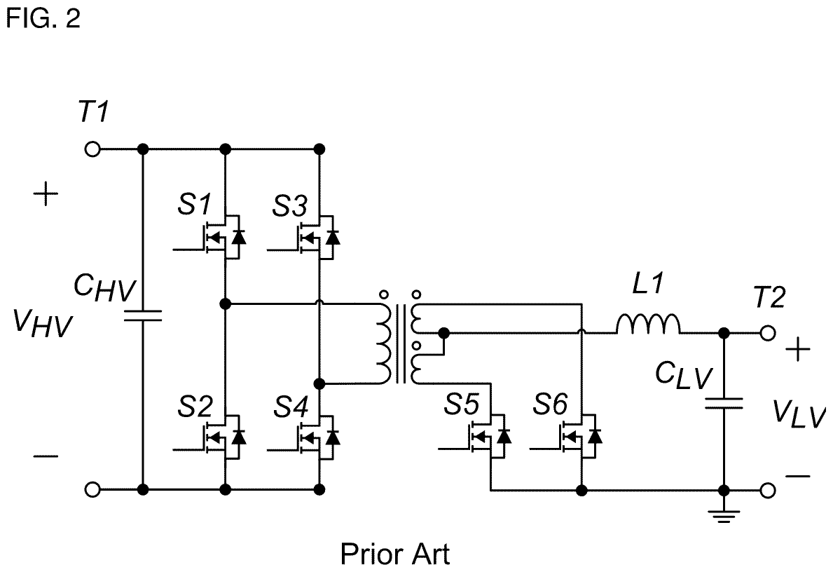

FIG. 3 shows a circuit diagram of a bidirectional direct current to direct current (DC-DC) converter according to a first embodiment of the present disclosure.

FIG. 4 shows a current flow of the bidirectional DC-DC converter according to the first embodiment of the present disclosure in mode 1-1 of a buck mode.

FIG. 5 shows a current flow of the bidirectional DC-DC converter according to the first embodiment of the present disclosure in mode 1-2 of the buck mode.

FIG. 6 shows a current flow of the bidirectional DC-DC converter according to the first embodiment of the present disclosure in mode 2-1 of a boost mode.

FIG. 7 shows a current flow of the bidirectional DC-DC converter according to the first embodiment of the present disclosure in mode 2-2 of the boost mode.

FIG. 8 shows a circuit of the bidirectional DC-DC converter according to the first embodiment of the present disclosure without including a fifth switch.

FIG. 9 shows a voltage of a high-voltage stage capacitor and a voltage of a clamp capacitor in the boost mode of the bidirectional DC-DC converter according to the first embodiment of the present disclosure without including the fifth switch.

FIG. 10 shows a voltage of a second terminal, a voltage across the clamp capacitor, and a pulse width modulation (PWM) waveform of first to fourth switches in the buck mode of the bidirectional DC-DC converter according to the first embodiment of the present disclosure without including the fifth switch.

FIG. 11 shows the voltage of the second terminal, the voltage across the clamp capacitor, and the PWM waveform of the first to fourth switches in the bidirectional DC-DC converter according to the first embodiment of the present disclosure without including the fifth switch, if no switching operation is performed.

FIG. 12 shows a flowchart of a control method of the bidirectional direct current to direct current (DC-DC) converter according to the first embodiment of the present disclosure.

FIG. 13 shows a timing diagram of a first embodiment 1-1 in which a controller controls a switch in a mode switching determination step.

FIG. 14 shows a timing diagram of a first embodiment 1-2 in which the controller controls the switch in the mode switching determination step.

FIG. 15 shows the voltage of the second terminal, the voltage across the clamp capacitor, and the PWM waveform of the first to fourth switches in the first embodiment.

FIG. 16 shows a circuit diagram of the bidirectional DC-DC converter according to a second embodiment of the present disclosure.

FIG. 17 shows a current flow of the bidirectional DC-DC converter according to the second embodiment of the present disclosure in mode 1-1 of the buck mode.

FIG. 18 shows a current flow of the bidirectional DC-DC converter according to the second embodiment of the present disclosure in mode 1-2 of the buck mode.

FIG. 19 shows a current flow of the bidirectional DC-DC converter according to the second embodiment of the present disclosure in mode 2-1 of the boost mode.

FIG. 20 shows a current flow of the bidirectional DC-DC converter according to the second embodiment of the present disclosure in mode 2-2 of the boost mode.

FIG. 21 shows a circuit of the bidirectional DC-DC converter according to the second embodiment of the present disclosure without including a discharge circuit.

FIG. 22 shows the voltages of the high-voltage stage capacitor and the clamp capacitor in the boost mode of the bidirectional DC-DC converter according to the second embodiment of the present disclosure without including the discharge circuit.

FIG. 23 shows the voltage of the second terminal, the voltage across the clamp capacitor, and the PWM waveform of the first to fourth switches in the buck mode of the bidirectional DC-DC converter according to the second embodiment of the present disclosure without including the discharge circuit.

FIG. 24 shows the voltage of the second terminal, the voltage across the clamp capacitor, and the PWM waveform of the first to fourth switches of the bidirectional DC-DC converter according to the second embodiment of the present disclosure without including the discharge circuit if no switching operation is performed.

FIG. 25 shows a circuit diagram of the bidirectional DC-DC converter according to a second embodiment 2-1 of the present disclosure.

FIG. 26 shows a circuit diagram of the bidirectional DC-DC converter according to a second embodiment 2-2 of the present disclosure.

FIG. 27 shows a circuit diagram of the bidirectional DC-DC converter according to a second embodiment 2-3 of the present disclosure.

FIG. 28 shows a flowchart of a control method of a bidirectional direct current to direct current (DC-DC) converter according to the second embodiment of the present disclosure.

FIG. 29 shows a timing diagram of a second embodiment 2-4 in which the controller controls the switch in the mode switching determination step.

FIG. 30 shows a timing diagram of a second embodiment 2-5 in which the controller controls the switch in the mode switching determination step.

FIG. 31 shows the voltage of the second terminal, the voltage across the clamp capacitor, and the PWM waveform of the first to fourth switches in the second embodiment.

### DETAILED DESCRIPTION

The above-mentioned objects, features, and advantages will become more obvious from the following embodiments provided in relation to the accompanying drawings. The following descriptions of specific structures and functions are provided as examples only to describe the embodiments based on a concept of the present disclosure. Therefore, the embodiments of the present disclosure may be implemented in various forms, and the present disclosure should not be construed as being limited to the embodiments described in the specification or the present application. The embodiments of the present disclosure may be variously modified and may have several forms, and specific embodiments are thus shown in the accompanying drawings and described in detail in the specification or the present application. However, it should be understood that the present disclosure is not limited to the specific embodiments, and includes all modifications, equivalents, and substitutions, included in the spirit and scope of the present disclosure. Terms such as “first”, “second”, or the like may be used to describe various components, and the components are not to be construed as being limited to the terms. The terms are used only to distinguish one component and another component from each other. For example, a “first” component may be named a “second” component and the “second” component may also be named the “first” component, without departing from the scope of the present disclosure. It should be understood that when one component is referred to as being “connected to” or “coupled to” another component, the corresponding component may be connected or coupled directly to another component or connected or coupled to another component with a third component interposed therebetween. On the other hand, it should be understood that when one component is referred to as being “connected directly to” or “coupled directly to” another component, one component may be connected or coupled to another component without any other component interposed therebetween. Other expressions to describe a relationship between the components, i.e., “~between” and “directly between” or “adjacent to” and “directly adjacent to”, should be interpreted in the same manner as above. Terms used in the specification are used only to describe the specific embodiments rather than limiting the present disclosure. Here, a term of a singular number includes its plural number unless explicitly interpreted otherwise in the context. It should be understood that terms “include”, “have”, or the like, used in the specification specify the presence of features, numerals, steps, operations, components, parts, or a combination thereof, stated in the present specification, and do not preclude the presence or addition of one or more other features, numerals, steps, operations, components, parts, or a combination thereof. Unless defined otherwise, it should be understood that all the terms including technical and scientific terms used herein have the same meanings as those generally understood by those skilled in the art to which the present disclosure pertains. Such terms as those defined in a generally used dictionary should be interpreted as having meanings equal to the contextual meanings in the relevant field of art, and should not be interpreted as having ideal or excessively formal meanings unless clearly defined as such in the present application. Hereinafter, the present disclosure is described in detail by describing a preferred embodiment of the present disclosure with reference to the accompanying drawings. Like reference numerals proposed in each drawing denote like components.

In this specification, a totem-pole circuit indicates a circuit in which two active elements are connected in series with each other, and a cascode circuit indicates a circuit in which three or more active elements are connected in series with each other.

A bidirectional direct current to direct current (DC-DC) converter 1 of the present disclosure has first and second embodiments.

### First Embodiment

The description describes the bidirectional DC-DC converter 1 according to the first embodiment of the present disclosure.

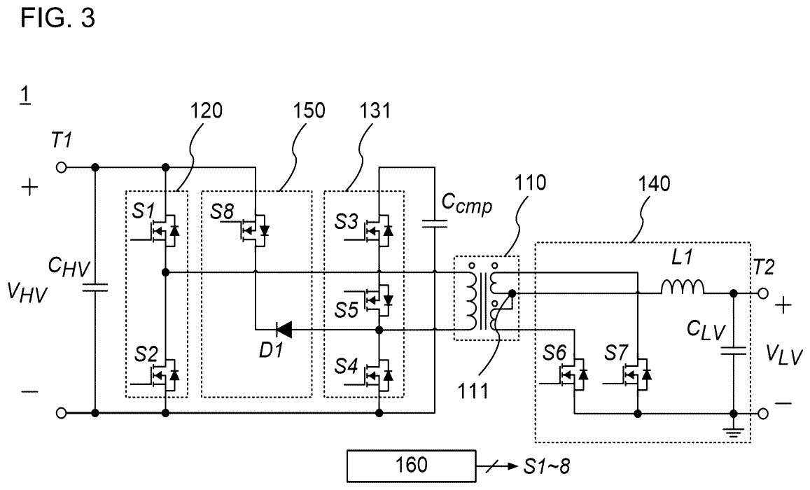

FIG. 3 shows a circuit diagram of a bidirectional direct current to direct current (DC-DC) converter 1 according to a first embodiment of the present disclosure.

The bidirectional DC-DC converter 1 according to the first embodiment of the present disclosure may include a first terminal T1, a second terminal T2, a transformer 110, a high-voltage side totem-pole circuit 120, a cascode circuit 131, a clamp capacitor C_{cmp}, a secondary-side circuit 140, an operation mode switching circuit 150, and a controller 160.

The first terminal T1 and the second terminal T2 may be connected to a first power and a second power having a lower potential than the first power, respectively. In detail, referring to FIG. 3, both ends of the first terminal T1 may be connected to the first power, and both ends of the second terminal T2 may be connected to the second power having the lower potential than the first power. In FIG. 3, V_{HV} indicates a voltage across the first terminal T1, and V_{LV} indicates a voltage across the second terminal T2.

As an example, the first terminal T1 may be a high-voltage stage, and a voltage in a range of 200 V to 900 V may be applied to the first terminal T1. In addition, the second terminal T2 may be a low-voltage stage, and a voltage in a range of 12 V to 14 V may be applied to the second terminal T2.

The first and second power may be a power supply device outputting a constant direct current power. As an example, the power supply device may be a secondary battery, or any one of other DC-DC converters.

The transformer 110 may be installed between the first terminal T1 and the second terminal T2. In detail, referring to FIG. 3, a primary side of the transformer 110 may be connected to the first terminal T1 through the high-voltage side totem-pole circuit 120, the cascode circuit 131, and the operation mode switching circuit 150. In addition, a secondary side of the transformer 110 may be connected to the second terminal T2 through the secondary-side circuit 140.

The transformer 110 may have one terminal and the other terminal installed on the primary side and have one terminal, the other terminal, and a predetermined tap 111 installed on the secondary side. One terminal on the primary side of the transformer 110 may be a dot terminal, and the other terminal on the primary side of the transformer 110 may be a non-dot terminal. In addition, one terminal on the secondary side of the transformer 110 may be the dot terminal, and the other terminal on the secondary side of the transformer 110 may be the non-dot terminal. In addition, the transformer 110 may have the predetermined tap 111 installed on the secondary side.

The high-voltage side totem-pole circuit 120 may be installed between the first terminal T1 and the primary side of the transformer 110, and include first and second switches S1 and S2. In detail, referring to FIG. 3, the first switch S1 may have one end connected to a positive pole of the first terminal T1 and the other end connected to one terminal on the primary side of the transformer 110. In addition, the second switch S2 may have one end connected to one terminal on the primary side of the transformer 110 and the other end connected to a negative pole of the first terminal T1.

The bidirectional DC-DC converter 1 according to the first embodiment of the present disclosure may further include a high-voltage stage capacitor C_{HV} installed between both the ends of the first terminal T1. In detail, referring to FIG. 3, the high-voltage stage capacitor C_{HV} may have one end connected to the positive pole of the first terminal T1 and the other end connected to the negative pole of the first terminal T1.

The cascode circuit 131 may be installed between the high-voltage side totem-pole circuit 120 and the primary side of the transformer 110, and include switches 3, 4, and 5 S3, S4, and S5 connected in series with one another. In detail, referring to FIG. 3, the third switch S3 may have one end connected to one end of the clamp capacitor C_{cmp} and the other end connected to the other end of the fifth switch S5. In addition, the fourth switch S4 may have one end connected to the other terminal on the primary side of the transformer 110 and the other end connected to the negative pole of the first terminal T1. In addition, the fifth switch S5 may have one end connected to the other terminal on the primary side of the transformer 110.

The clamp capacitor C_{cmp} may be connected in parallel with the cascode circuit 131. In detail, referring to FIG. 3, the clamp capacitor C_{cmp} may have one end connected to one end of the third switch S3 and the other end connected to the other end of the fourth switch S4.

The secondary-side circuit 140 may be installed between the transformer 110 on the secondary side of the transformer 110 and the second terminal T2, and include sixth and seventh switches S6 and S7 and an inductor L1. In detail, referring to FIG. 3, the sixth switch S6 may have one end connected to the other terminal on the secondary side of the transformer 110 and the other end connected to a negative pole of the second terminal T2. In addition, the seventh switch S7 may have one end connected to one terminal on the secondary side of the transformer 110 and the other end connected to the negative pole of the second terminal T2. In addition, the inductor L1 may have one end connected to the tap 111 of the transformer 110 and the other end connected to a positive pole of the second terminal T2.

The secondary-side circuit 140 may be operated as a synchronous rectifier circuit that rectifies an alternating current (AC) voltage transmitted from the secondary side of the transformer 110 into a DC voltage under control of the controller 160 and outputs the same to the second terminal T2.

The secondary-side circuit 140 may further include a low-voltage stage capacitor C_{LV} installed between both the ends of the second terminal T2. In detail, referring to FIG. 3, the low-voltage stage capacitor C_{LV} may have one end connected to the positive pole of the second terminal T2 and the other end connected to the negative pole of the first terminal T1.

The operation mode switching circuit 150 may be installed between the high-voltage side totem-pole circuit 120 and the cascode circuit 131, and include an eighth switch S8 and a first diode D1 connected in series with each other. In detail, referring to FIG. 3, the eighth switch S8 may have one end connected to an anode of the first diode D1 and the other end connected to the positive pole of the first terminal T1. In addition, a cathode of the first diode D1 may be connected to the other terminal on the primary side of the transformer 110.

In a buck mode, the operation mode switching circuit 150 may turn off the eighth switch S8, thereby disconnecting the other terminal on the primary side of the transformer 110 from the first terminal T1. However, in a boost mode, the operation mode switching circuit 150 may turn on the eighth switch S8, thereby connecting the other terminal on the primary side of the transformer 110 to the first terminal T1 to thus perform a boost operation.

The controller 160 may control at least one of the first to eighth switches S1 to S8, and control the operation mode switching circuit 150 based on a power flow direction between the first and second terminals T1 and T2. In detail, the controller 160 may control at least one of the first to eighth switches S1 to S8 in the buck mode or the boost mode based on the power flow direction between the first and second terminals T1 and T2. The buck mode indicates an operation of transferring power of the first power connected to the first terminal T1 to the second power connected to the second terminal T2, and the boost mode indicates an operation of transferring power of the second power to the first power.

The power flow direction between the first and second terminals T1 and T2 may be determined based on whether a voltage of the first terminal T1 is greater than or equal to a predetermined mode switching reference voltage V_{TH1}. In detail, the controller 160 may control the operation mode switching circuit 150 based on whether the voltage of the first terminal T1 is greater than or equal to the predetermined mode switching reference voltage V_{TH1}. In detail, the controller 160 may control the bidirectional DC-DC converter 1 to be in the buck mode when the voltage of the first terminal T1 is greater than or equal to the predetermined mode switching reference voltage V_{TH1}, and control the bidirectional DC-DC converter 1 in the boost mode when the voltage of the first terminal T1 is less than the predetermined mode switching reference voltage V_{TH1}.

Next, the description describes a method of the controller 160 to control the first to eighth switches S1 to S8 in the buck mode or the boost mode.

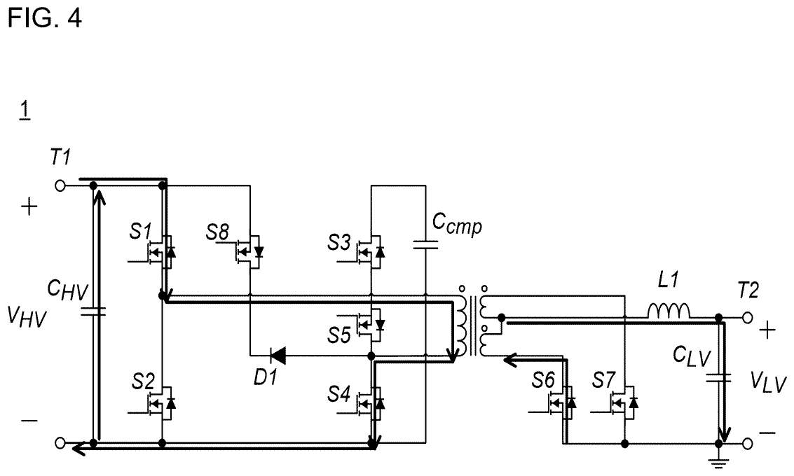

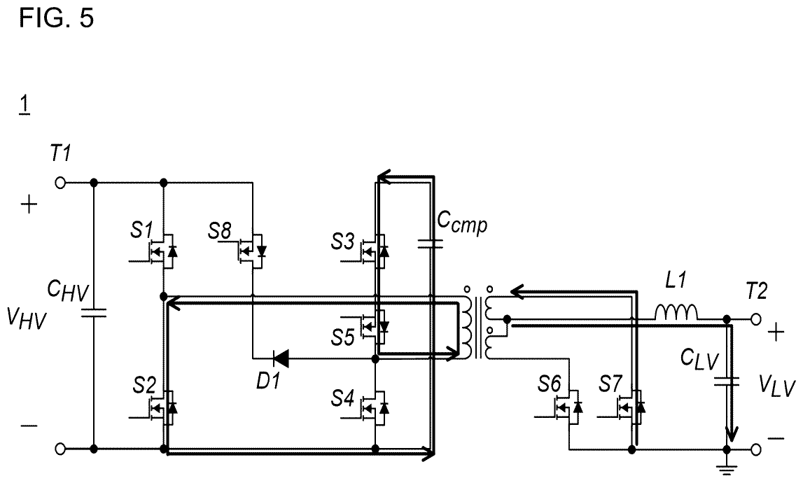

FIG. 4 shows a current flow of the bidirectional DC-DC converter 1 according to the first embodiment of the present disclosure in mode 1-1 of the buck mode, and FIG. 5 shows a current flow of the bidirectional DC-DC converter 1 according to the first embodiment of the present disclosure in mode 1-2 of the buck mode.

In the buck mode, the controller 160 may control the first and fourth switches S1 and S4 and the second, third, and fifth switches S2, S3, and S5 to be complementarily turned on. In detail, the controller 160 may control the first to eighth switches S1 to S8 in mode 1-1 or mode 1-2 of the buck mode. Referring to FIG. 4, in mode 1-1, the controller 160 may control the first, fourth, and sixth switches S1, S4, and S6 to be turned on, and control the second, third, fifth, and seventh switches S2, S3, S5, and S7 to be turned off. In addition, referring to FIG. 5, in mode 1-2, the controller 160 may control the first, fourth, and sixth switches S1, S4, and S6 to be turned off, and the second, third, fifth, and seventh switches S2, S3, S5, and S7 to be turned on.

In addition, in the buck mode, the controller 160 may control the eighth switch S8 be turned off. In detail, referring to FIGS. 4 and 5, the controller 160 may control the eighth switch S8 to be turned off regardless of mode 1-1 or mode 1-2 of the buck mode. Therefore, the high-voltage side totem-pole circuit 120 and the cascode circuit 131 may be disconnected from each other, thus preventing a closed circuit from being formed between the high-voltage side totem-pole circuit 120 and the cascode circuit 131.

In this way, the bidirectional DC-DC converter 1 may buck a high voltage applied to the first terminal T1 in the buck mode and output a low voltage to the second terminal T2.

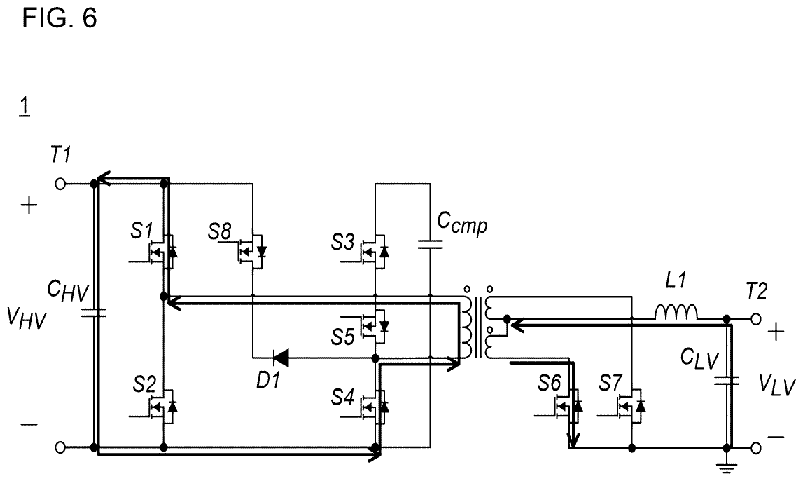

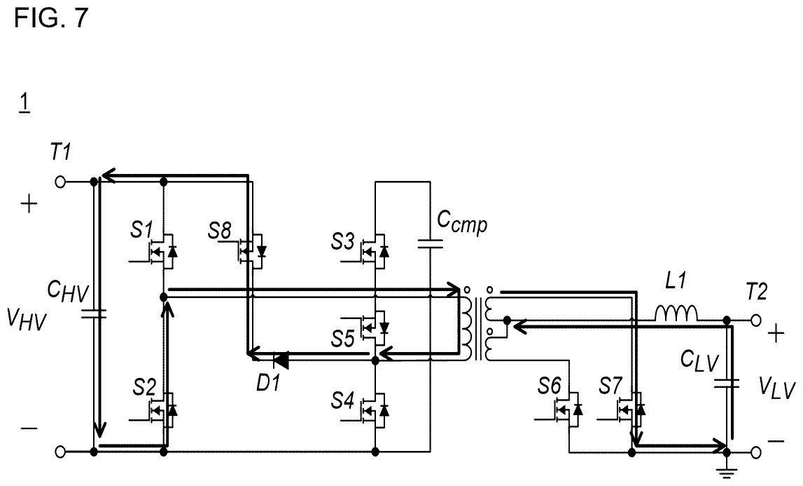

FIG. 6 shows a current flow of the bidirectional DC-DC converter 1 according to the first embodiment of the present disclosure in mode 2-1 of the boost mode, and FIG. 7 shows a current flow of the bidirectional DC-DC converter 1 according to the first embodiment of the present disclosure in mode 2-2 of the boost mode.

In the boost mode, the controller 160 may control the first and fourth switches S1 and S4 and the second and eighth switches S2 and S8 to be complementarily turned on. In detail, in the boost mode, the controller 160 may control the first to eighth switches S1 to S8 in mode 2-1 or mode 2-2. Referring to FIG. 6, in mode 2-1, the controller 160 may control the first, fourth, and sixth switches S1, S4, and S6 to be turned on, and control the second, seventh, and eighth switches S2, S7, and S8 to be turned off. In addition, referring to FIG. 7, in mode 2-2, the controller 160 may control the second, seventh, and eighth switches S2, S7, and S8 to be turned on, and the first, fourth, and sixth switches S1, S4, and S6 to be turned off. Here, the controller 160 may control the third switch S3 to be turned off regardless of mode 2-1 or mode 2-2 of the boost mode.

In addition, in the boost mode, the controller 160 may control the fifth switch S5 be turned off. In detail, referring to FIGS. 6 and 7, the controller 160 may control the fifth switch S5 to be turned off regardless of mode 2-1 or mode 2-2 of the boost mode. The controller 160 may control the fifth switch S5 to be turned off, thereby preventing the clamp capacitor from being charged through a body diode of the third switch S3.

The first to eighth switches S1 to S8 may be active elements, which may be, for example, metal-oxide-semiconductor (MOS) transistors or insulated gate bipolar transistors (IGBTs). Each of the first to eighth switches S1 to S8 may include the body diode.

In this way, the bidirectional DC-DC converter 1 may boost the low voltage applied to the second terminal T2 in the boost mode and output the high voltage to the first terminal T1.

As a result, the controller 160 may control the first to eighth switches S1 to S8 in the buck mode and the boost mode, and the bidirectional DC-DC converter 1 may thus perform buck and boost operations in both directions.

### Method for Preventing Charging of Clamp Capacitor C_{cmp}

Next, the description describes a method for preventing the charging of the clamp capacitor C_{cmp} according to the first embodiment and its effect.

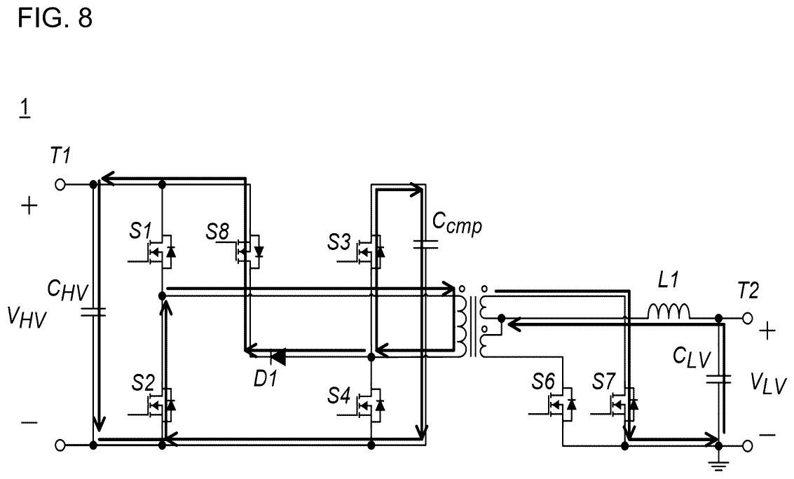

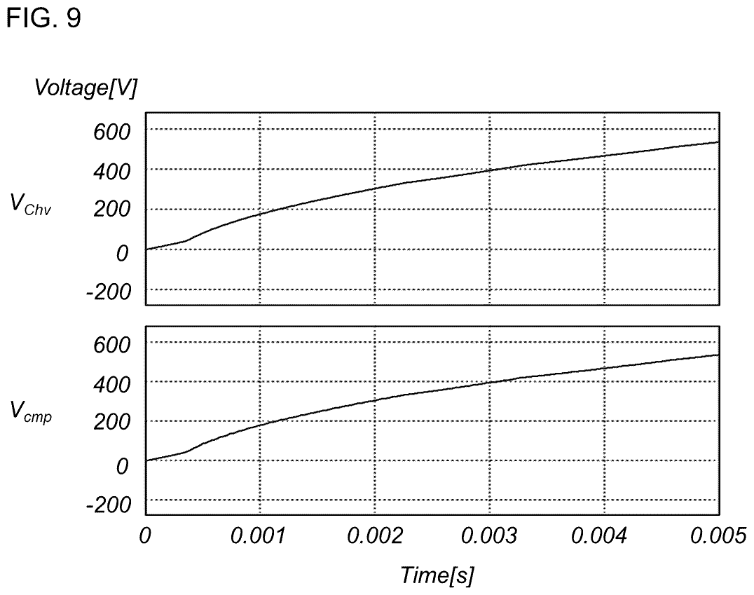

FIG. 8 shows a circuit of the bidirectional DC-DC converter 1 according to the first embodiment of the present disclosure without including a fifth switch S5, and FIG. 9 shows a voltage of the high-voltage stage capacitor C_{HV} and a voltage of the clamp capacitor C_{cmp} in the boost mode of the bidirectional DC-DC converter 1 according to the first embodiment of the present disclosure without including the fifth switch S5.

V_{Chv} indicates the voltage across the high-voltage stage capacitor C_{HV}, and V_{cmp} indicates the voltage across the clamp capacitor C_{cmp}.

Unlike FIG. 3, the bidirectional DC-DC converter 1 shown in FIG. 8 does not include the fifth switch S5. Accordingly, the other end of the third switch S3 may be connected to the other terminal on the primary side of the transformer 110. In this case, the clamp capacitor C_{cmp} may be charged by the body diode of the third switch S3 in mode 2-1 of the boost mode. Simultaneously, the high-voltage stage capacitor C_{HV} may also be charged. Therefore, as shown in FIG. 9, the voltage across the clamp capacitor C_{cmp} and the voltage across the high-voltage stage capacitor C_{HV} may be increased. That is, overvoltage may be applied to the second terminal T2, to which a voltage lower than the voltage of the first terminal T1 is applied when switching the mode from mode 2-2 of the boost mode to mode 1-1 of the buck mode, under a condition where the bidirectional DC-DC converter 1 does not include the fifth switch S5.

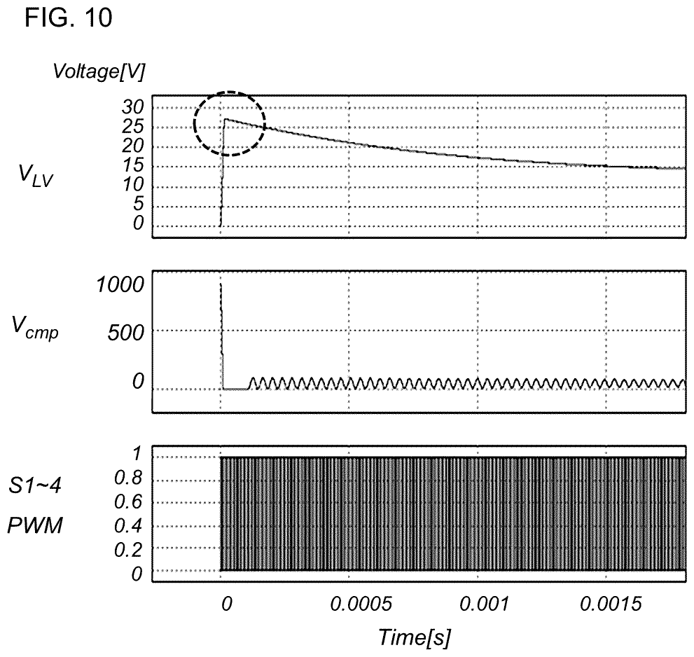

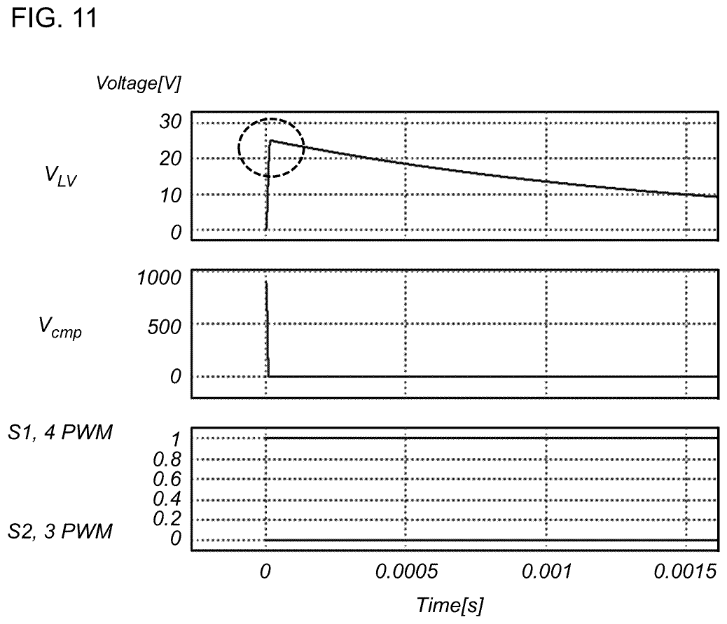

FIG. 10 shows a voltage of the second terminal T2, the voltage across the clamp capacitor C_{cmp}, and a pulse width modulation (PWM) waveform of the first to fourth switches in the buck mode of the bidirectional DC-DC converter 1 according to the first embodiment of the present disclosure without including the fifth switch S5, and FIG. 11 shows the voltage of the second terminal T2, the voltage across the clamp capacitor C_{cmp}, and the PWM waveform of the first to fourth switches in the bidirectional DC-DC converter 1 according to the first embodiment of the present disclosure without including the fifth switch S5, if no switching operation is performed.

In detail, as shown in FIG. 10, an overvoltage of approximately 27 V may be applied to the second terminal T2 when the switching operation is performed in the buck mode after the boost mode, and as shown in FIG. 11, a high voltage of approximately 25 V may be applied to the second terminal T2 even when no switching operation is performed. The second terminal T2 may correspond to the low-voltage stage, and it may be seen that 25 to 27 V may be considered the overvoltage compared to its allowable voltage range of 12 to 14 V. Accordingly, a load connected to the second terminal T2 may be damaged due to the overvoltage.

Therefore, in order to solve the above problem, the fifth switch S5 may be installed as shown in FIG. 3 to prevent the clamp capacitor C_{cmp} from being charged in mode 2-2 of the boost mode.

In detail, referring to FIG. 3, each of the third and fifth switches S3 and S5 may include the body diode, and the third switch S3 and the fifth switch S5 may be connected to each other to allow the cathode of the body diode included in the third switch S3 to be connected to the cathode of the body diode included in the fifth switch S5.

As a result, the clamp capacitor C_{cmp} may be prevented from being charged in mode 2-2 of the boost mode by installing the fifth switch S5 in the cascode circuit 131, and the overvoltage may be prevented from occurring in the second terminal T2 when switching the mode from the boost mode to the buck mode.

### Control Method of Bidirectional DC-DC Converter 1 According to First Embodiment

Next, the description describes the control method of a bidirectional DC-DC converter 1 according to the first embodiment of the present disclosure.

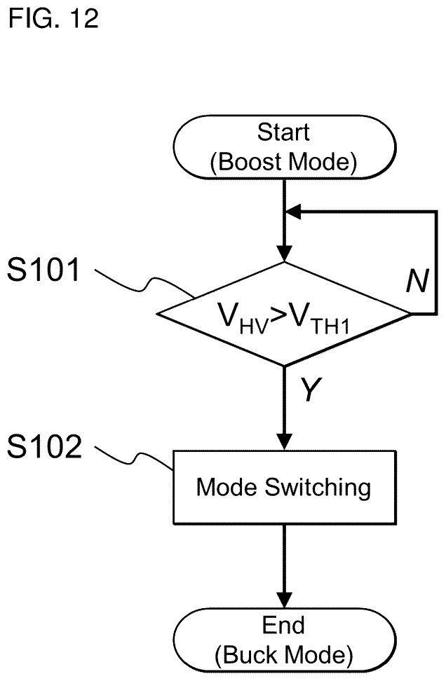

FIG. 12 shows a flow chart of the control method of a bidirectional DC-DC converter 1 according to the first embodiment of the present disclosure.

Referring to FIG. 12, the control method of a bidirectional DC-DC converter 1 according to the first embodiment of the present disclosure may include a mode switching determination step (S101) and an operation mode switching step (S102).

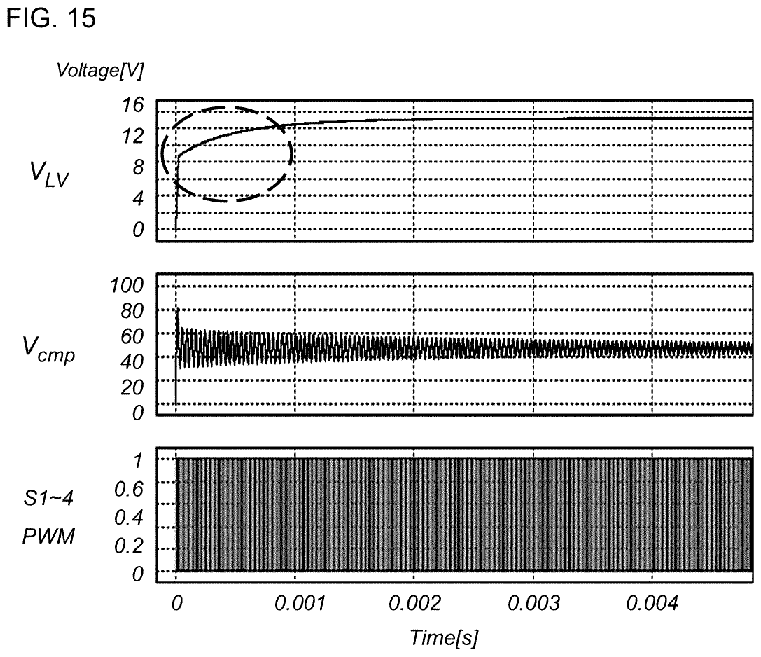

In the mode switching determination step (S101), the controller 160 may determine whether the voltage of the first terminal T1 is greater than or equal to the predetermined mode switching reference voltage V_{TH1}. In detail, referring to FIG. 15, in order to determine whether to switch the mode from the boost mode to the buck mode, the controller 160 may determine whether the voltage of the first terminal T1 is greater than or equal to the predetermined mode switching reference voltage V_{TH1}.

The reason is that power may be transferred to the second terminal T2 by bucking the voltage only when the voltage of the first terminal T1 is greater than or equal to the predetermined mode switching reference voltage V_{TH1}.

In the mode switching determination step (S101), the controller 160 may control the fifth switch S5 using a predetermined turning-on duty ratio, and control the fifth switch S5 to have a phase difference of half a cycle from the sixth switch S6 while controlling the sixth switch S6 using the predetermined turning-on duty ratio.

Next, the description describes a method of the controller 160 for controlling the switch in the mode switching determination step (S101).

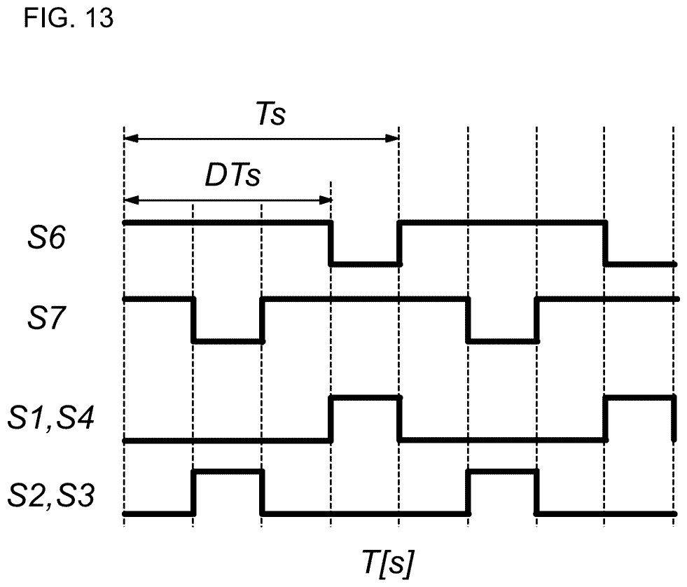

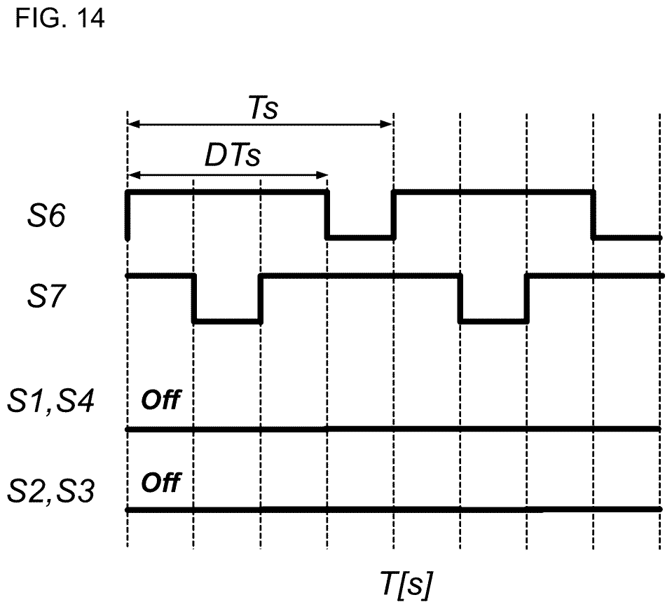

FIG. 13 shows a timing diagram of a first embodiment 1-1 in which the controller 160 controls the switch in the mode switching determination step (S101), and FIG. 14 shows a timing diagram of a first embodiment 1-2 in which the controller 160 controls the switch in the mode switching determination step (S101).

In detail, referring to FIGS. 13 and 14, in the mode switching determination step (S101), the controller 160 may control the first to third, sixth and seventh switches S1 to S3, S6, and S7 using a predetermined cycle Ts, and control the seventh switch S7 to have a phase difference of half a cycle from the sixth switch S6 while controlling the sixth and seventh switches S6 and S7 to have the predetermined turning-on duty ratio D.

However, the controller 160 may control the first to fourth switches S1 to S4 according to the first embodiments 1-1 and 1-2.

Referring to FIG. 13, in the first embodiment 1-1, in the mode switching determination step (S1), the controller 160 may control the first and fourth switches S1 and S4 and the sixth switch S6 to be complementarily turned on, and in the mode switching determination step (S101), the controller 160 may control the second and third switches S2 and S3 and the seventh switch S7 to be complementarily turned on.

Referring to FIG. 14, in the first embodiment 1-2, in the mode switching determination step (S1), the controller 160 may control the first to fourth switches S1 to S4 to be turned off.

In the operation mode switching step (S102), the controller 160 may control at least one of the first to eighth switches in the buck mode if the voltage of the first terminal T1 is greater than or equal to the mode switch reference voltage V_{TH1}. In addition, in the operation mode switching step (S102), the controller 160 may control the fifth switch S5 to be turned on and the eighth switch to be turned off. In detail, referring to FIG. 15, in the operation mode switching step (S102), the controller 160 may control the fifth switch S5 to be turned on, and the eighth switch S8 to be turned off, as in mode 2-2 of the buck mode if the voltage of the first terminal T1 is higher than the mode switch reference voltage V_{TH1}.

As a result, the bidirectional DC-DC converter 1 may switch the mode from the boost mode to the buck mode more stably.

### Effect of Bidirectional DC-DC Converter 1 According to First Embodiment

FIG. 15 shows the voltage of the second terminal T2, the voltage across the clamp capacitor C_{cmp}, and the PWM waveform of the first to fourth switches S1 to S4 in the first embodiment.

FIGS. 10 and 11, which are graphs of the bidirectional DC-DC converter 1 that does not discharge the clamp capacitor C_{cmp}, show that an overvoltage of approximately 25 V to 27 V is applied to the second terminal T2. On the other hand, referring to FIG. 15, it may be confirmed that an overvoltage of 14 V or more does not occur in the present disclosure.

### Second Embodiment

Next, the description describes the bidirectional DC-DC converter 1 according to the second embodiment of the present disclosure.

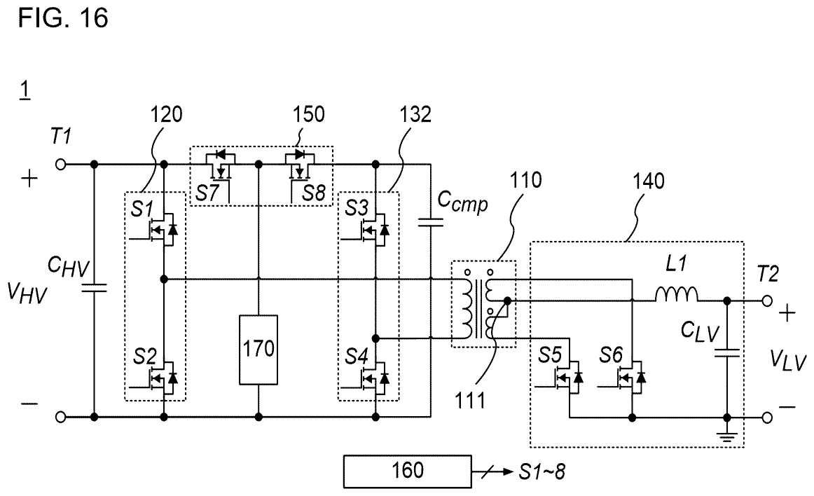

FIG. 16 shows a circuit diagram of the bidirectional DC-DC converter 1 according to the second embodiment of the present disclosure.

The bidirectional DC-DC converter 1 according to the second embodiment of the present disclosure may include the first terminal T1, the second terminal T2, the transformer 110, the high-voltage side totem-pole circuit 120, a transformer-side totem-pole circuit 132, the clamp capacitor C_{cmp}, the secondary-side circuit 140, the operation mode switching circuit 150, the controller 160, and a discharge circuit 170.

The first terminal T1 and the second terminal T2 may be connected to the first power and the second power having the lower potential than the first power, respectively. In detail, referring to FIG. 16, both the ends of the first terminal T1 may be connected to the first power, and both the ends of the second terminal T2 may be connected to the second power having the lower potential than the first power. In FIG. 16, V_{HV} indicates the voltage across the first terminal T1, and V_{LV} indicates the voltage across the second terminal T2.

As an example, the first terminal T1 may be the high-voltage stage, and the voltage in the range of 200 V to 900 V may be applied to the first terminal T1. In addition, the second terminal T2 may be the low-voltage stage, and the voltage in the range of 12 V to 14 V may be applied to the second terminal T2.

The first and second power may be the power supply device outputting the constant direct current power. As an example, the power supply device may be the secondary battery, or any one of other DC-DC converters.

The transformer 110 may be installed between the first terminal T1 and the second terminal T2. In detail, referring to FIG. 16, the primary side of the transformer 110 may be connected to the first terminal T1 through the high-voltage side totem-pole circuit 120, the transformer-side totem-pole circuit 132, and the operation mode switching circuit 150. In addition, the secondary side of the transformer 110 may be connected to the second terminal T2 through the secondary-side circuit 140.

The transformer 110 may have one terminal and the other terminal installed on the primary side, and have one terminal, the other terminal, and the predetermined tap 111 installed on the secondary side. One terminal on the primary side of the transformer 110 may be the dot terminal, and the other terminal on the primary side of the transformer 110 may be the non-dot terminal. In addition, one terminal on the secondary side of the transformer 110 may be the dot terminal, and the other terminal on the secondary side of the transformer 110 may be the non-dot terminal. In addition, the transformer 110 may have the predetermined tap 111 installed on the secondary side.

The high-voltage side totem-pole circuit 120 may be installed between the first terminal T1 and the primary side of the transformer 110, and include first and second switches S1 and S2. In detail, referring to FIG. 16, the first switch S1 may have one end connected to the positive pole of the first terminal T1 and the other end connected to one terminal on the primary side of the transformer 110. In addition, the second switch S2 may have one end connected to one terminal on the primary side of the transformer 110 and the other end connected to the negative pole of the first terminal T1.

The bidirectional DC-DC converter 1 according to the second embodiment of the present disclosure may further include the high-voltage stage capacitor C_{HV} installed between both the ends of the first terminal T1. In detail, referring to FIG. 16, the high-voltage stage capacitor C_{HV} may have one end connected to the positive pole of the first terminal T1 and the other end connected to the negative pole of the first terminal T1.

The transformer-side totem-pole circuit 132 may be installed between the high-voltage side totem-pole circuit 120 and the primary side of the transformer 110, and include the third and fourth switches S3 and S4. In detail, referring to FIG. 16, the third switch S3 may have one end connected to one end of the clamp capacitor C_{cmp} and the other end connected to the other terminal on the primary side of the transformer 110. In addition, the fourth switch S4 may have one end connected to the other terminal on the primary side of the transformer 110 and the other end connected to the negative pole of the first terminal T1.

The clamp capacitor C_{cmp} may be connected in parallel with the transformer-side totem-pole circuit 132. In detail, referring to FIG. 16, the clamp capacitor C_{cmp} may have one end connected to one end of the third switch S3 and the other end connected to the other end of the fourth switch S4.

The secondary-side circuit 140 may be installed between the transformer 110 on the secondary side of the transformer 110 and the second terminal T2, and include the fifth and sixth switches S5 and S6 and the inductor L1. In detail, referring to FIG. 16, the fifth switch S5 may have one end connected to the other terminal on the secondary side of the transformer 110 and the other end connected to the negative pole of the second terminal T2. In addition, the sixth switch S6 may have one end connected to one terminal on the secondary side of the transformer 110 and the other end connected to the negative pole of the second terminal T2. In addition, the inductor L1 may have one end connected to the tap 111 of the transformer 110 and the other end connected to the positive pole of the second terminal T2.

The secondary-side circuit 140 may be operated as the synchronous rectifier circuit that rectifies the alternating current (AC) voltage transmitted from the secondary side of the transformer 110 into the DC voltage under the control of the controller 160 and outputs the same to the second terminal T2.

The secondary-side circuit 140 may further include the low-voltage stage capacitor C_{LV} installed between both the ends of the second terminal T2. In detail, referring to FIG. 16, the low-voltage stage capacitor C_{LV} may have one end connected to the positive pole of the second terminal T2 and the other end connected to the negative pole of the first terminal T1.

The operation mode switching circuit 150 may be installed between the high-voltage side totem-pole circuit 120 and the transformer-side totem-pole circuit 132, and include the seventh and eighth switches S7 and S8 connected in series with each other. In detail, referring to FIG. 16, the seventh switch S7 may have one end connected to the positive pole of the first terminal T1 and the other end connected to the other end of the eighth switch S8. In addition, one end of the eighth switch S8 may be connected to one end of the clamp capacitor C_{cmp}. That is, the operation mode switching circuit according to the second embodiment has a different circuit structure from that of the operation mode switching circuit according to the first embodiment.

The controller 160 may control at least one of the first to eighth switches S1 to S8, and control the operation mode switching circuit 150 based on the power flow direction between the first and second terminals T1 and T2. In detail, the controller 160 may control at least one of the first to eighth switches S1 to S8 in the buck mode or the boost mode based on the power flow direction between the first and second terminals T1 and T2. The buck mode indicates the operation of transferring the power of the first power connected to the first terminal T1 to the second power connected to the second terminal T2, and the boost mode indicates the operation of transferring the power of the second power to the first power.

The controller 160 may determine the power flow direction between the first and second terminals T1 and T2 based on whether the voltage of the first terminal T1 is greater than or equal to the predetermined mode switching reference voltage V_{TH1}. In detail, the controller may control the operation mode switching circuit 150 based on whether the voltage of the first terminal T1 is greater than or equal to the predetermined mode switching reference voltage V_{TH1}. In detail, the controller 160 may control the bidirectional DC-DC converter 1 to be in the buck mode when the voltage of the first terminal T1 is greater than or equal to the predetermined mode switching reference voltage V_{TH1}, and control the bidirectional DC-DC converter 1 to be in the boost mode when the voltage of the first terminal T1 is less than the predetermined mode switching reference voltage V_{TH1}.

Next, the description describes a method of the controller 160 to control the first to eighth switches S1 to S8 in the buck mode or the boost mode.

The controller 160 may control the first and fourth switches S1 and S4 and the second and third switches S2 and S3 to be complementarily turned on in the buck mode or the boost mode.

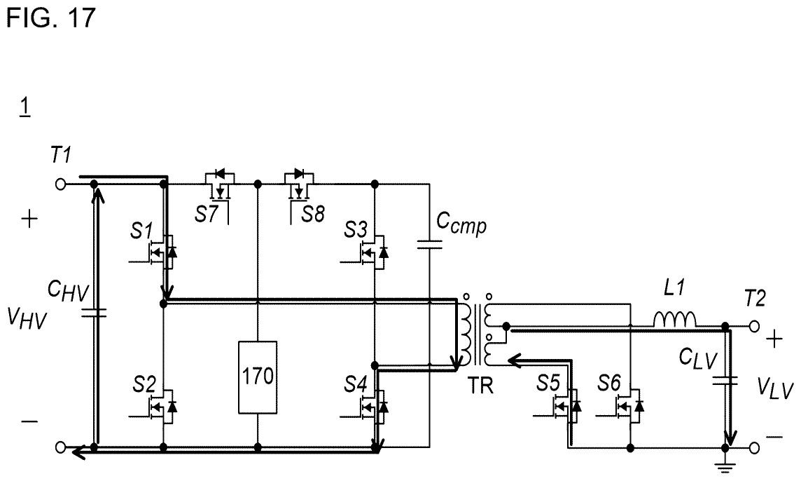

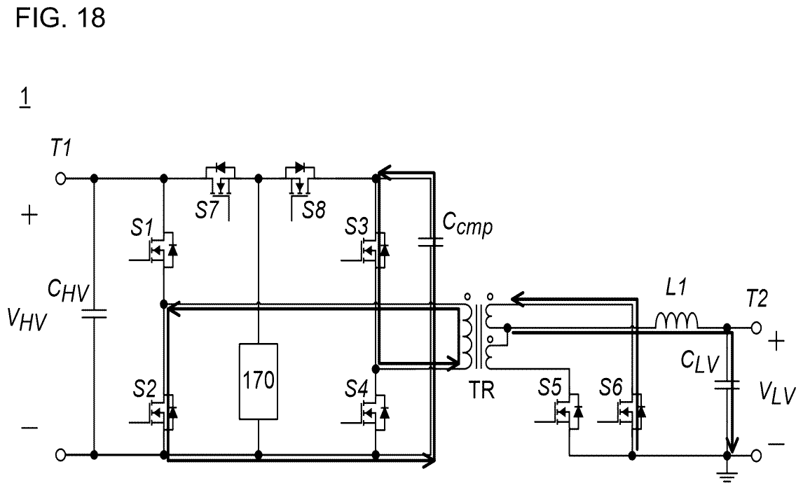

FIG. 17 shows a current flow of the bidirectional DC-DC converter 1 according to the second embodiment of the present disclosure in mode 1-1 of the buck mode, and FIG. 18 shows a current flow of the bidirectional DC-DC converter 1 according to the second embodiment of the present disclosure in mode 1-2 of the buck mode.

In the buck mode, the controller 160 may control the first and fourth switches S1 and S4 and the second and third switches S2 and S3 to be complementarily turned on. In detail, the controller 160 may control the first to eighth switches S1 to S8 in mode 1-1 or mode 1-2 of the buck mode. Referring to FIG. 17, in mode 1-1, the controller 160 may control the first, fourth, and fifth switches S1, S4, and S5 to be turned on, and control the second, third, and sixth switches S2, S3, and S6 to be turned off. Referring to FIG. 18, in mode 1-2, the controller 160 may control the first, fourth, and fifth switches S1, S4, and S5 to be turned off, and control the second, third, and sixth switches S2, S3, and S6 to be turned on.

In addition, in the buck mode, the controller 160 may control both the seventh and eighth switches S7 and S8 to be turned off. Therefore, a connection branch between the high-voltage side totem-pole circuit 120 and the transformer-side totem-pole circuit 132 may be disconnected, thus preventing a closed circuit from being formed between the high-voltage side totem-pole circuit 120 and the transformer-side totem-pole circuit 132.

In this way, the bidirectional DC-DC converter 1 may buck the high voltage applied to the first terminal T1 in the buck mode and output the low voltage to the second terminal T2.

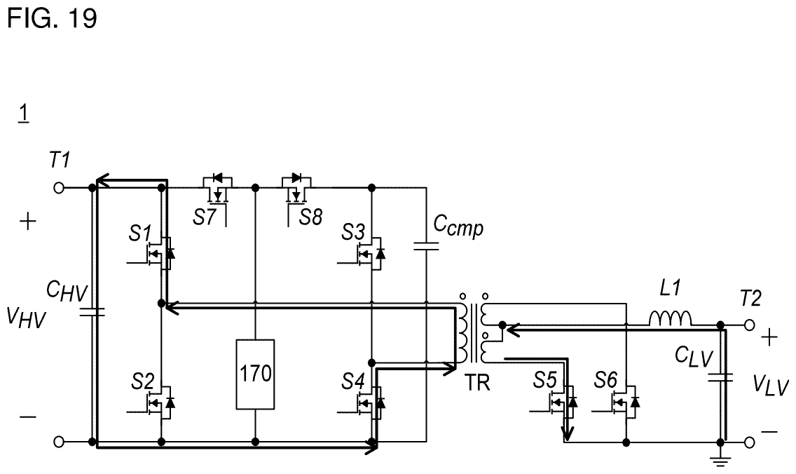

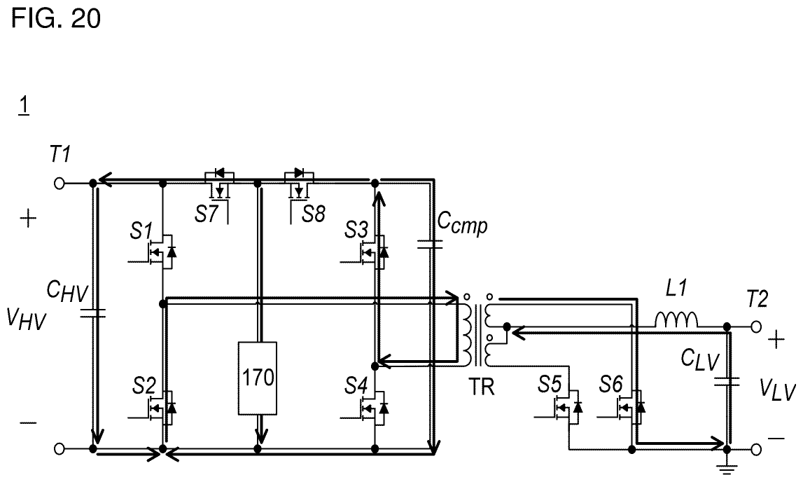

FIG. 19 shows a current flow of the bidirectional DC-DC converter 1 according to the second embodiment of the present disclosure in mode 2-1 of the boost mode, and FIG. 20 shows a current flow of the bidirectional DC-DC converter 1 according to the second embodiment of the present disclosure in mode 2-2 of the boost mode.

The controller 160 may control the first and fourth switches S1 and S4 and the second and third switches S2 and S3 to be complementarily turned on in the boost mode, as well as in the buck mode. In detail, the controller 160 may control the first to eighth switches S1 to S8 in mode 2-1 or mode 2-2 of the boost mode. Referring to FIG. 19, in mode 2-1, the controller 160 may control the first, fourth, and fifth switches S1, S4, and S5 to be turned on, and the second, third, and sixth switches S2, S3, and S6 to be turned off. In addition, referring to FIG. 20, in mode 2-2, the controller 160 may control the first, fourth, and fifth switches S1, S4, and S5 to be turned off, and the second, third, and sixth switches S2, S3, and S6 to be turned on.

However, a difference from the buck mode is that the controller 160 controls both the seventh and eighth switches S7 and S8 to be turned on in the boost mode. In detail, referring to FIGS. 19 and 20, the controller may control both the seventh and eighth switches S7 and S8 to be turned off in mode 2-1, and control both the seventh and eighth switches S7 and S8 to be turned on in mode 2-1. Therefore, the high-voltage side totem-pole circuit 120 and the transformer-side totem-pole circuit 132 may be connected to each other using the seventh and eighth switches S7 and S8.

In this way, the bidirectional DC-DC converter 1 according to the second embodiment may boost the low voltage applied to the second terminal T2 in the boost mode and output the high voltage to the first terminal T1.

The first to eighth switches S1 to S8 may be the active elements, which may be, for example, the metal-oxide-semiconductor (MOS) transistors or the insulated gate bipolar transistors (IGBTs). Each of the first to eighth switches S1 to S8 may include the body diode.

As a result, the controller 160 may control the first to eighth switches S1 to S8 in the buck mode and the boost mode, and the bidirectional DC-DC converter 1 may thus perform the buck and boost operations in both the directions.

### Discharge Mode of Clamp Capacitor C_{cmp}

Next, the description describes a discharge mode of the clamp capacitor C_{cmp}.

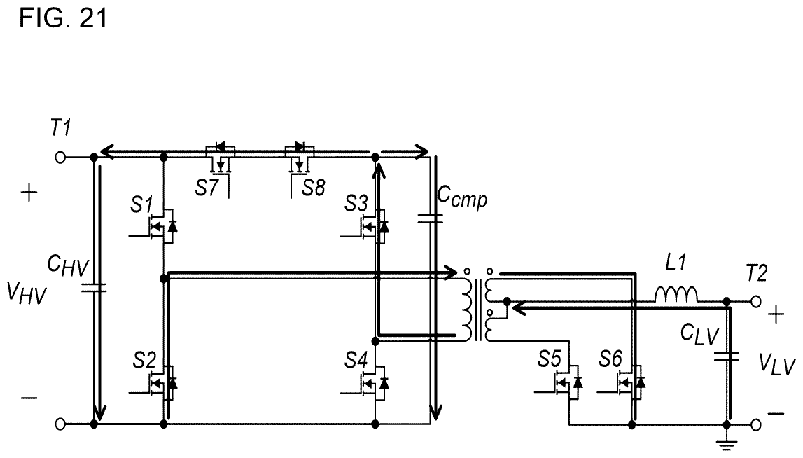

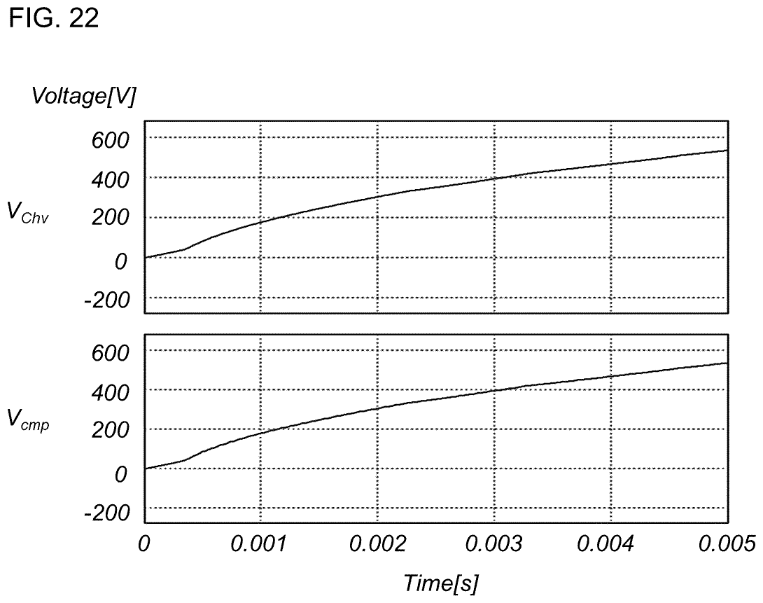

FIG. 21 shows a circuit of the bidirectional DC-DC converter 1 according to the second embodiment of the present disclosure without including a discharge circuit 170, and FIG. 22 shows the voltages of the high-voltage stage capacitor C_{HV} and the clamp capacitor C_{cmp} in the boost mode of the bidirectional DC-DC converter 1 according to the second embodiment of the present disclosure without including the discharge circuit 170.

V_{Chv} indicates the voltage across the high-voltage stage capacitor C_{HV}, and V_{cmp} indicates the voltage across the clamp capacitor C_{cmp}.

Referring to FIGS. 20, 21, and 22, in mode 2-2 of the boost mode, the high-voltage stage capacitor C_{HV} and the clamp capacitor C_{cmp} may be simultaneously charged to thus boost the voltage of the high-voltage stage capacitor C_{HV} and the voltage across the clamp capacitor C_{cmp}, thereby accumulating energy. That is, the overvoltage may be applied to the second terminal T2, to which the voltage lower than the voltage of the first terminal T1 is applied when switching the mode from mode 2-2 of the boost mode to mode 1-1 of the buck mode, under a condition where the bidirectional DC-DC converter 1 includes no circuit capable of discharging the clamp capacitor C_{cmp} as shown in FIG. 21.

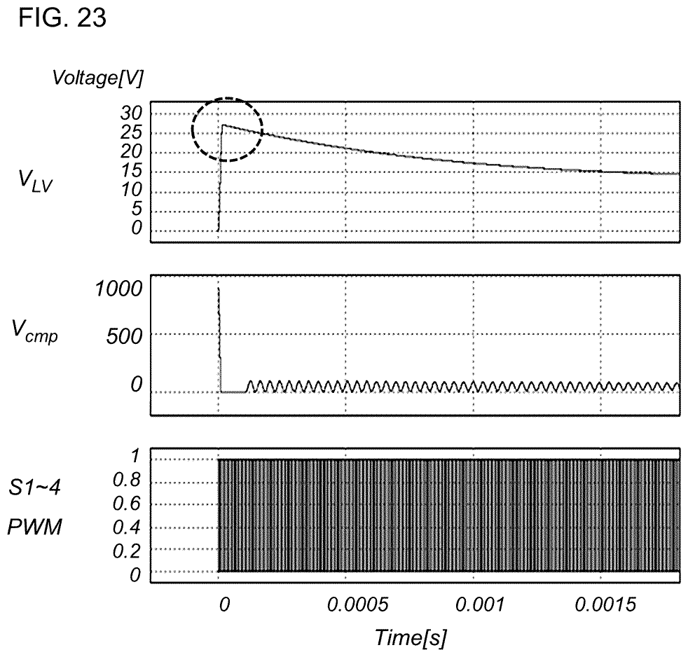

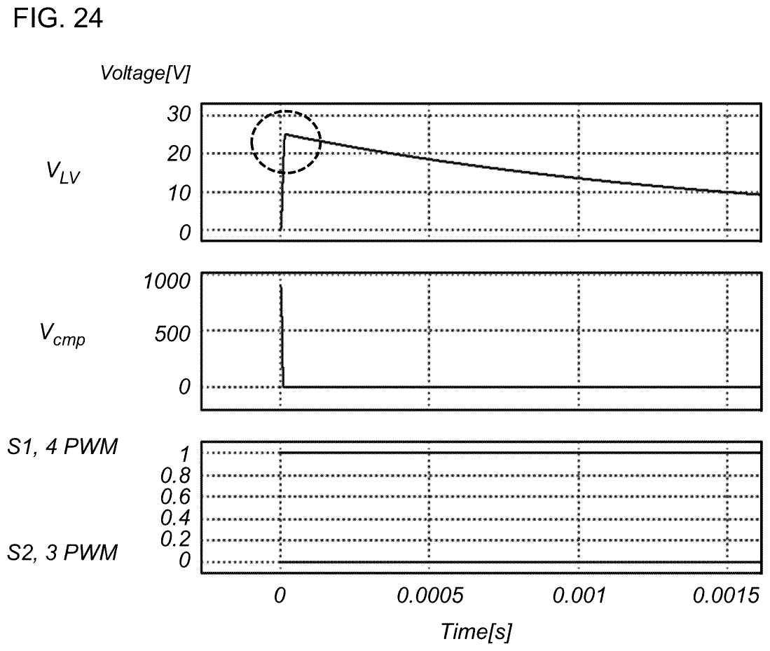

FIG. 23 shows the voltage of the second terminal T2, the voltage across the clamp capacitor C_{cmp}, and the PWM waveform of the first to fourth switches S1 to S4 in the buck mode of the bidirectional DC-DC converter 1 according to the second embodiment of the present disclosure without including the discharge circuit 170, and FIG. 24 shows the voltage of the second terminal T2, the voltage across the clamp capacitor C_{cmp}, and the PWM waveform of the first to fourth switches S1 to S4 of the bidirectional DC-DC converter 1 according to the second embodiment of the present disclosure without including the discharge circuit 170 if no switching operation is performed.

In detail, as shown in FIG. 23, the overvoltage of approximately 27 V may be applied to the second terminal T2 when the switching operation is performed in the buck mode after the boost mode, and as shown in FIG. 24, the high voltage of approximately 25 V may be applied to the second terminal T2 even when no switching operation is performed. The second terminal T2 may correspond to the low-voltage stage, and it may be seen that 25 V to 27 V may be considered the overvoltage compared to its allowable voltage range of 12 V to 14 V. Accordingly, the load connected to the second terminal T2 may be damaged due to the overvoltage.

Therefore, in order to solve the above problem, the controller 160 may control the first to eighth switches S1 to S8 in the buck mode and the boost mode as well as in the discharge mode. Next, the description describes an embodiment in which the controller 160 discharges the clamp capacitor C_{cmp} in the discharge mode.

### Second Embodiment 2-1

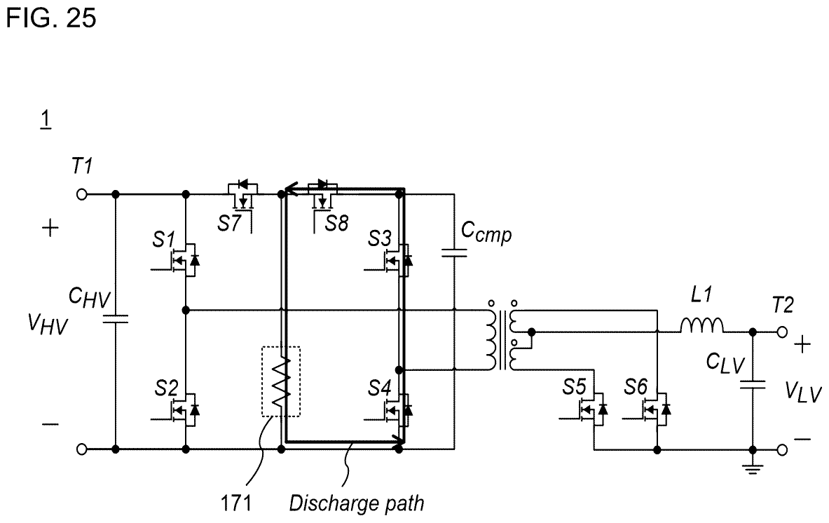

FIG. 25 shows a circuit diagram of the bidirectional DC-DC converter 1 according to the second embodiment 2-1 of the present disclosure.

The bidirectional DC-DC converter 1 according to the second embodiment of the present disclosure may further include the discharge circuit 170. In detail, referring to FIG. 25, the discharge circuit 170 may be installed between a common node of the seventh and eighth switches S7 and S8 and a primary-side ground.

In this case, in the second embodiment 2-1, the discharge circuit 170 may include a resistance element 171. In detail, referring to FIG. 25, the resistance element 171 may have one end connected to the common node of the seventh and eighth switches S7 and S8 and the other end connected to the primary-side ground of the transformer 110.

In addition, the controller 160 may control the seventh switch S7 to be turned off and the eighth switch S8 to be turned on if the voltage across the clamp capacitor C_{cmp} is greater than a predetermined discharge reference voltage V_{TH2}. In detail, referring to FIG. 25, the controller 160 may determine whether the voltage across the clamp capacitor C_{cmp} is greater than the predetermined discharge reference voltage V_{TH2} requiring the discharge when switching the mode from the boost mode to the buck mode. The controller 160 may control the first to seventh switches S1 to S7 to be turned off and the eighth switch S8 to be turned on if the voltage across the clamp capacitor C_{cmp} is greater than the predetermined discharge reference voltage V_{TH2}.

In this way, before switching the mode from the boost mode to the buck mode, a discharge path may be configured as shown in FIG. 25 to allow energy remaining in the clamp capacitor C_{cmp} to be discharged through the resistance element 171, thereby preventing the overvoltage from occurring in the buck mode in advance.

### Second Embodiment 2-2

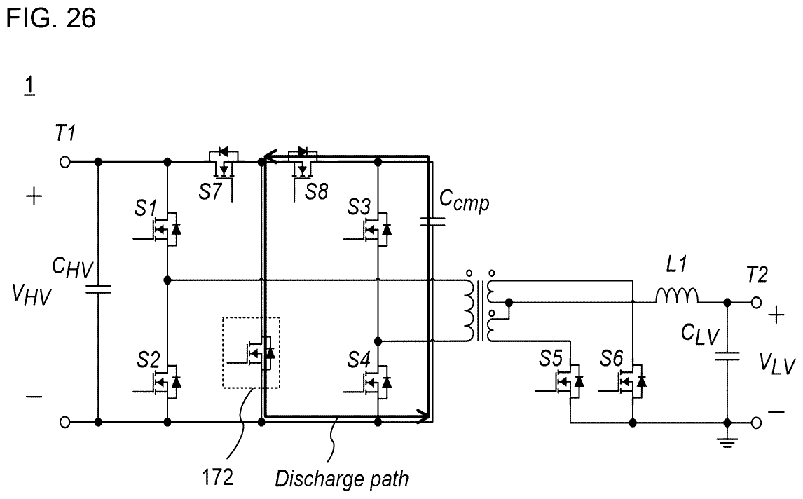

FIG. 26 shows a circuit diagram of the bidirectional DC-DC converter 1 according to the second embodiment 2-2 of the present disclosure.

As in the second embodiment 2-1, in the second embodiment 2-2, the bidirectional DC-DC converter 1 may further include the discharge circuit 170. In addition, the controller 160 may control the seventh switch S7 to be turned off and the eighth switch S8 to be turned on if the voltage across the clamp capacitor C_{cmp} is greater than the predetermined discharge reference voltage V_{TH2}. The description omits a detailed description of this configuration within the scope overlapping with that in the second embodiment 2-1.

However, the discharge circuit 170 in the 2-2 embodiment may include a switch element 172. In detail, referring to FIG. 26, the switch element 172 may have one end connected to the common node of the seventh and eighth switches S7 and S8 and the other end connected to the primary-side ground of the transformer 110.

In addition, the controller 160 may control the switch element 172 included in the discharge circuit 170 to be turned on if the voltage across the clamp capacitor C_{cmp} is greater than the predetermined discharge reference voltage V_{TH2}.

In this way, as in the second embodiment 2-1, before switching the mode from the boost mode to the buck mode, the discharge path may be configured as shown in FIG. 26 to allow the energy remaining in the clamp capacitor C_{cmp} to be discharged through the switch element 172, thereby preventing the overvoltage from occurring in the buck mode in advance.

### Second Embodiment 2-39

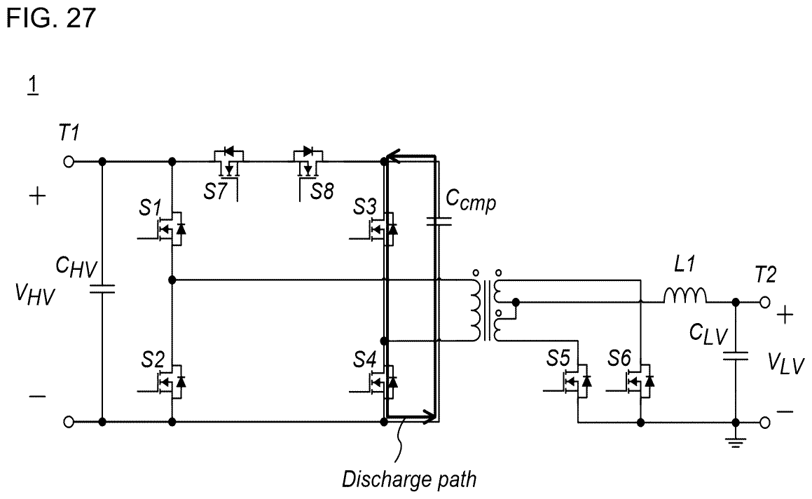

FIG. 27 shows a circuit diagram of the bidirectional DC-DC converter 1 according to the second embodiment 2-3 of the present disclosure.

The controller 160 may control the seventh and eighth switches S7 and S8 to be turned off and the third and fourth switches S3 and S4 to be turned on if the voltage across the clamp capacitor C_{cmp} is greater than the predetermined discharge reference voltage V_{TH2}. In detail, referring to FIG. 27, the controller 160 may determine whether the voltage across the clamp capacitor C_{cmp} is greater than the predetermined discharge reference voltage V_{TH2} requiring the discharge when switching the mode from the boost mode to the buck mode. The controller 160 may control the first, second, and fifth to eighth switches S1, S2, and S5 to S8 to be turned off and the third and fourth switches S3 and S4 to be turned on if the voltage across the clamp capacitor C_{cmp} is greater than the predetermined discharge reference voltage V_{TH2}.

Unlike the discharge circuit 170 installed separately in the second embodiment 2-1 or 2-2, in the second embodiment 2-3, the transformer-side totem-pole circuit 132 may be used to configure the discharge path as shown in FIG. 27 to thus discharge charging energy of the clamp capacitor C_{cmp}, thereby reducing a design and manufacturing cost of the bidirectional DC-DC converter 1.

### Control Method of Bidirectional DC-DC Converter 1 According to Second Embodiment

Next, the description describes the control method of a bidirectional DC-DC converter 1 according to the second embodiment of the present disclosure.

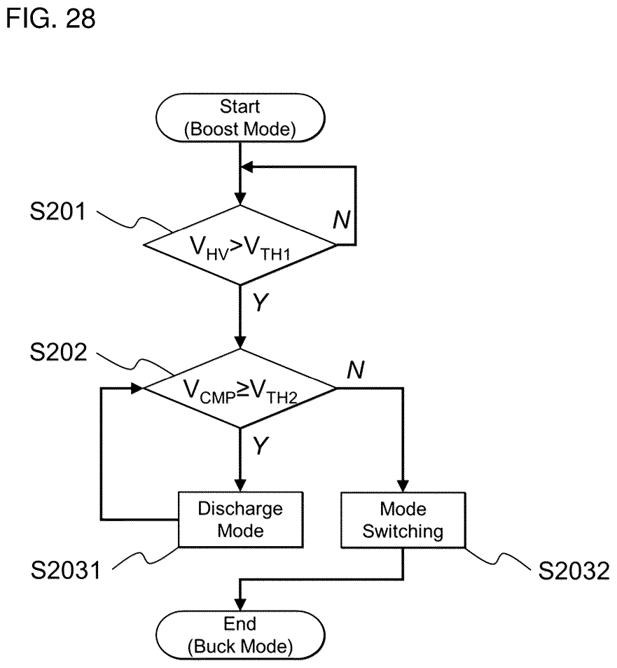

FIG. 28 shows a flowchart of the control method of a bidirectional direct current to direct current (DC-DC) converter 1 according to the second embodiment of the present disclosure.

Referring to FIG. 28, the control method of a bidirectional DC-DC converter 1 may include a mode switching determination step (S201), a discharge determination step (S202), a discharge mode step (S2031), and an operation mode switching step (S2032). In detail, the controller 160 may control the first to eighth switches S1 to S8 to switch the mode from the boost mode to the buck mode. Therefore, before the mode switching determination step, the bidirectional DC-DC converter 1 may be operated in the boost mode.

In the mode switching determination step (S201), the controller 160 may determine whether the voltage of the first terminal T1 is greater than or equal to the predetermined mode switching reference voltage V_{TH1}. In detail, referring to FIG. 28, in order to determine whether to switch the mode from the boost mode to the buck mode, the controller 160 may determine whether the voltage of the first terminal T1 is greater than or equal to the predetermined mode switching reference voltage V_{TH1}.

The reason is that the power may be transferred to the second terminal T2 by bucking the voltage only when the voltage of the first terminal T1 is greater than or equal to the predetermined mode switching reference voltage V_{TH1}.

In the mode switching determination step (S201), the controller 160 may control the fifth switch S5 using the predetermined turning-on duty ratio, and control the fifth switch S5 to have the phase difference of half a cycle from the sixth switch S6 while controlling the sixth switch S6 using the predetermined turning-on duty ratio.

Next, the description describes a method of the controller 160 for controlling the switch in the mode switching determination step.

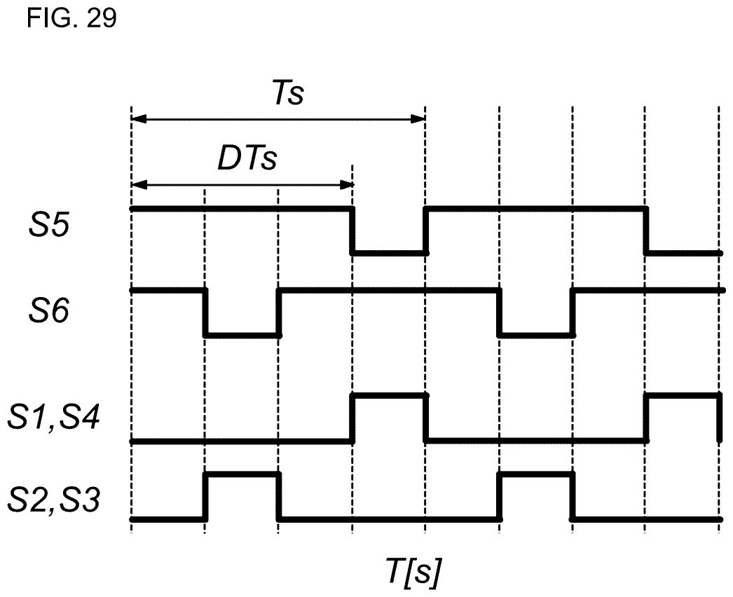

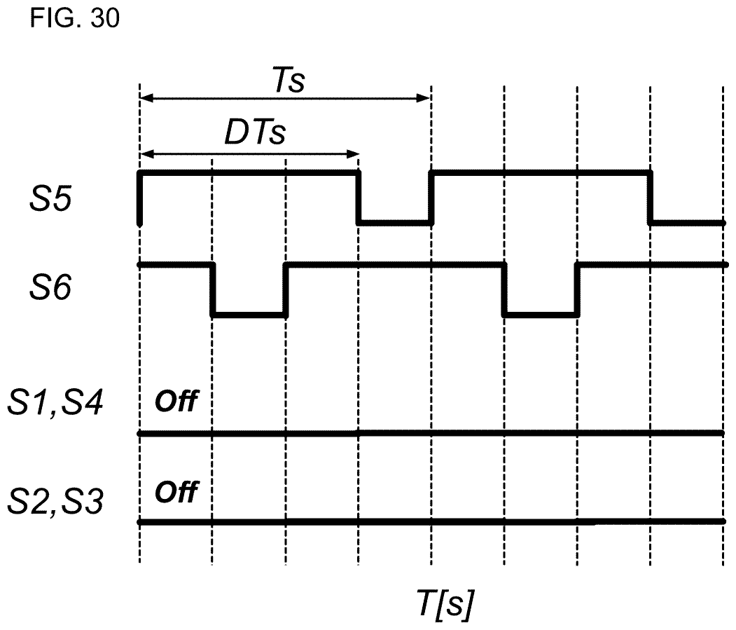

FIG. 29 shows a timing diagram of a second embodiment 2-4 in which the controller 160 controls the switch in the mode switching determination step, and FIG. 30 shows a timing diagram of a second embodiment 2-5 in which the controller 160 controls the switch in the mode switching determination step.

In detail, referring to FIGS. 29 and 30, in the mode switching determination step, the controller 160 may control the first to sixth switches S1 to S6 using the predetermined cycle Ts, and control the sixth switch S6 to have the phase difference of half a cycle from the fifth switch S5 while controlling each of the fifth and sixth switches S5 and S6 to have the predetermined turning-on duty ratio D.

However, the controller 160 may control the first to fourth switches S1 to S4 according to the second embodiments 2-4 and 2-5.

Referring to FIG. 29, in the second embodiment 2-4, the controller 160 may control the first and fourth switches S1 and S4 and to be complementarily turned on, and control the second and third switches S2 and S3 and the sixth switch S6 to be complementarily turned on.

Referring to FIG. 30, in the second embodiment 2-5, the controller 160 may control the first to fourth switches S1 to S4 to be turned off.

In this way, the bidirectional DC-DC converter 1 may switch the mode from the boost mode to the buck mode more stably.

In the discharge determination step (S202), the controller 160 may determine whether the voltage across the clamp capacitor C_{cmp} is greater than the predetermined discharge reference voltage V_{TH2} if the voltage of the first terminal T1 is greater than the mode switch reference voltage V_{TH1}. The controller 160 may determine whether the voltage across the clamp capacitor Ccmp is greater than the predetermined discharge reference voltage VTH2, the reason being that there is a high risk that the load connected to the second terminal T2 may be damaged because the overvoltage is applied to the second terminal T2 if the mode switches to the buck mode without discharging the clamp capacitor C_{cmp} under the condition where the mode may switch from the boost mode to the buck mode.

In the discharge mode step (S2031), the controller 160 may discharge the clamp capacitor C_{cmp} when the voltage across the clamp capacitor C_{cmp} is greater than and equal to the predetermined discharge reference voltage V_{TH2}.

The bidirectional DC-DC converter 1 may further include the discharge circuit 170 installed between the common node of the seventh and eighth switches S7 and S8 and the primary-side ground, and in the discharge mode step (S2031), the controller 160 may control the seventh switch S7 to be turned off and the eighth switch S8 to be turned on to allow the clamp capacitor C_{cmp} to be discharged.

The method of the bidirectional DC-DC converter 1 including the discharge circuit 170 for discharging the clamp capacitor C_{cmp} is described in the second embodiments 2-1 and 2-2, and its description is thus omitted from this paragraph.

In the discharge mode step (S2031), the controller 160 may control the seventh and eighth switches S7 and S8 to be turned off, and the third and fourth switches S3 and S4 to be turned on.

The method of the bidirectional DC-DC converter 1 without including the discharge circuit 170 for discharging the clamp capacitor C_{cmp} is described in the second embodiment 2-3, and its description is thus omitted from this paragraph.

In the operation mode switching step (S2032), the controller 160 may control at least one switch among the first to eighth switches in the buck mode if the voltage across the clamp capacitor C_{cmp} is less than the reference voltage after the discharge determination step (S202).

As a result, the bidirectional DC-DC converter 1 may switch the mode from the boost mode to the buck mode more stably.

### Effect of Bidirectional DC-DC Converter 1 According to Second Embodiment

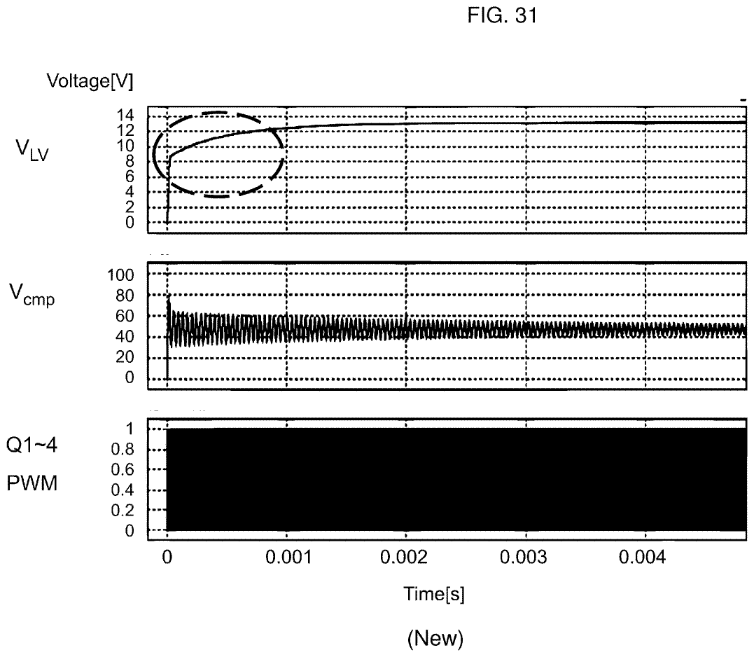

FIG. 31 shows the voltage of the second terminal T2, the voltage across the clamp capacitor C_{cmp}, and the PWM waveform of the first to fourth switches S1 to S4 in the second embodiment.

FIGS. 23 and 24, which are the graphs of the bidirectional DC-DC converter 1 that does not discharge the clamp capacitor C_{cmp}, show that the overvoltage of approximately 25 V to 27 V is applied to the second terminal T2. On the other hand, referring to FIG. 31, it may be confirmed that the overvoltage of 14 V or more does not occur in the second embodiment.

As a result, according to the bidirectional DC-DC converter 1 and its control method in the present disclosure, the bidirectional DC-DC converter 1 may be operated over the wide input voltage range, and perform the bidirectional power conversion in the buck mode and the boost mode.

In addition, the bidirectional DC-DC converter 1 may be operated stably by suppressing the overvoltage of the low-voltage stage that may occur when switching the operation mode from the boost mode to the buck mode to thus protect the load connected to the low-voltage stage from the overvoltage.

According to the bidirectional DC-DC converter and its control method of the present disclosure as described above, the bidirectional DC-DC converter may be operated over the wide input voltage range, similar to the conventional unidirectional converter, and may simultaneously perform the bidirectional power conversion in the buck mode and the boost mode, similar to the conventional bidirectional converter.

In addition, the bidirectional DC-DC converter may be stably operated by further including the switch capable of preventing the charging of the clamp capacitor when the boost mode is operated to thus suppress the overvoltage of the low-voltage stage that may occur when the boost mode is operated, thereby protecting the load connected to the low-voltage stage from the overvoltage.

In addition, the bidirectional DC-DC converter may have the improved reliability and stability by suppressing the overvoltage of the low-voltage stage that may occur when switching its operation mode from the boost mode to the buck mode to thus protect the load connected to the low-voltage stage from the overvoltage.

Although the embodiments of the present disclosure are described as above, the embodiments disclosed in the present disclosure are provided to fully describe the present disclosure rather than limit the spirit of the present disclosure. Therefore, the spirit of the present disclosure may include not only each disclosed embodiment but also a combination of the disclosed embodiments. Further, the scope of the present disclosure is not limited to these embodiments. In addition, it is apparent to those skilled in the art to which the present disclosure pertains that various variations and modifications could be made without departing from the spirit and scope of the appended claims, and all such appropriate variations and modifications should be considered as falling within the scope of the present disclosure as equivalents.

What is claimed is:

1. A bidirectional direct current to direct current (DC-DC) converter, the converter comprising:
a first terminal and a second terminal, each connected to a first power and a second power having a lower potential than the first power;
a transformer installed between the first terminal and the second terminal;
a high-voltage side totem-pole circuit including first and second switches, and installed between the first terminal and a primary side of the transformer;
a cascode circuit including third, fourth, and fifth switches connected in series with one another, and installed between the high-voltage side totem-pole circuit and the primary side of the transformer;
a clamp capacitor connected in parallel with the cascode circuit;
a secondary-side circuit including sixth and seventh switches and an inductor, and installed between the second terminal and a secondary side of the transformer;
an operation mode switching circuit including an eighth switch and a first diode connected in series with each other, and installed between the high-voltage side totem-pole circuit and the cascode circuit; and
a controller configured to:
control at least one of the first to eighth switches; and
control the operation mode switching circuit based on a power flow direction between the first and second terminals.

2. The converter of claim 1, wherein in a buck mode, the controller is further configured to control the eighth switch to be turned off.

3. The converter of claim 1, wherein in a boost mode, the controller is further configured to control the fifth switch to be turned off.

4. The converter of claim 1, wherein in a buck mode, the controller is further configured to control the first and fourth switches and the second, third, and fifth switches to be complementarily turned on.

5. The converter of claim 1, wherein in a boost mode, the controller is further configured to control the first and fourth switches and the second and eighth switches to be complementarily turned on.

6. The converter of claim 1, wherein the first switch has one end connected to a positive pole of the first terminal and the other end connected to one terminal on the primary side of the transformer, and
wherein the second switch has one end connected to the one terminal on the primary side of the transformer and the other end connected to a negative pole of the first terminal.

7. The converter of claim 1, wherein the third switch has one end connected to one end of the clamp capacitor and the other end connected to the other end of the fifth switch,
wherein the fourth switch has one end connected to the other terminal on the primary side of the transformer and the other end connected to the negative pole of the first terminal,
wherein the fifth switch has one end connected to the other terminal on the primary side of the transformer, and
wherein the clamp capacitor has the other end connected to the other end of the fourth switch.

8. The converter of claim 1, wherein the eighth switch has one end connected to an anode of the first diode and the other end connected to the positive pole of the first terminal, and
wherein a cathode of the first diode is connected to the other terminal on the primary side of the transformer.

9. The converter of claim 1, wherein a tap is installed on the secondary side of the transformer,
wherein the sixth switch has one end connected to the other terminal on the secondary side of the transformer and the other end connected to a negative pole of the second terminal,
wherein the seventh switch has one end connected to one terminal on the secondary side of the transformer and the other end connected to the negative pole of the second terminal, and
wherein the inductor has one end connected to the tap of the transformer and the other end connected to a positive pole of the second terminal.

10. A control method of a bidirectional direct current to direct current (DC-DC) converter as claimed in claim 1, the method comprising:
a mode switching determination step of determining, by a controller, whether a voltage of a first terminal is greater than or equal to a predetermined mode switching reference voltage; and
an operation mode switching step of controlling, by the controller, at least one switch among first to eighth switches in a buck mode in response to the voltage of the first terminal being greater than or equal to the mode switch reference voltage.

11. A bidirectional direct current to direct current (DC-DC) converter, the converter comprising:
a first terminal and a second terminal, each connected to a first power and a second power having a lower potential than the first power;
a transformer installed between the first terminal and the second terminal;
a high-voltage side totem-pole circuit including first and second switches, and installed between the first terminal and a primary side of the transformer;
a transformer-side totem-pole circuit including third and fourth switches, and installed between the high-voltage side totem-pole circuit and the primary side of the transformer;
a clamp capacitor connected in parallel with the transformer-side totem-pole circuit;
a secondary-side circuit including fifth and sixth switches and an inductor, and installed between the second terminal and a secondary side of the transformer;
an operation mode switching circuit including seventh and eighth switches connected in series with each other, and installed between the high-voltage side totem-pole circuit and the transformer-side totem-pole circuit; and
a controller configured to:
control at least one of the first to eighth switches; and
control the operation mode switching circuit based on a power flow direction between the first and second terminals.

12. The converter of claim 11, wherein in a buck mode, the controller is further configured to control both the seventh and eighth switches to be turned off.

13. The converter of claim 11, wherein in a boost mode, the controller is further configured to control both the seventh and eighth switches to be turned on.

14. The converter of claim 11, wherein the controller is further configured to control the first and fourth switches and the second and third switches to be complementarily turned on.

15. The converter of claim 11, further comprising a discharge circuit installed between a common node of the seventh and eighth switches and a primary-side ground,
wherein the controller is further configured to control the seventh switch to be turned off and the eighth switch to be turned on in response to a voltage across the clamp capacitor being greater than a predetermined discharge reference voltage.

16. The converter of claim 11, wherein the controller is further configured to control the seventh and eighth switches to be turned off and the third and fourth switches to be turned on in response to a voltage across the clamp capacitor being greater than a predetermined discharge reference voltage.

17. The converter of claim 11, wherein the first switch has one end connected to a positive pole of the first terminal and the other end connected to one terminal on the primary side of the transformer, and
wherein the second switch has one end connected to the one terminal on the primary side of the transformer and the other end connected to a negative pole of the first terminal.

18. The converter of claim 11, wherein the third switch has one end connected to one end of the clamp capacitor and the other end connected to the other terminal on the primary side of the transformer,
wherein the fourth switch has one end connected to the other terminal on the primary side of the transformer and the other end connected to a negative pole of the first terminal, and
wherein the clamp capacitor has the other end connected to the negative pole of the first terminal.

19. The converter of claim 11, wherein the seventh switch has one end connected to a positive pole of the first terminal and the other end connected to the other end of the eighth switch, and
wherein the eighth switch has one end connected to one end of the clamp capacitor.

20. The converter of claim 11, wherein a tap is installed on the secondary side of the transformer,
wherein the fifth switch has one end connected to the other terminal on the secondary side of the transformer and the other end connected to a negative pole of the second terminal,
wherein the sixth switch has one end connected to one terminal on the secondary side of the transformer and the other end connected to the negative pole of the second terminal, and
wherein the inductor has one end connected to the tap of the transformer and the other end connected to a positive pole of the second terminal.
